(19) United States
(12) Patent Application Publication
(10) Pub. No.: US 2026/0257160 A1
(43) Pub. Date: Sep. 3, 2026

(54) FILTER MEDIA FOR FILTRATION DEVICES AND METHODS OF MAKING AND USING THE SAME

(71) Applicant: 3M INNOVATIVE PROPERTIES COMPANY, St. Paul, MN (US)

(72) Inventors: Wenli Wang, Woodbury, MN (US); Daniel J. Zillig, Woodbury, MN (US); Paul A. Martinson, Maplewood, MN (US); Jennifer A. Chaisson, Kemptville (CA); Carrie L. Spencer, Brockville (CA); Nathan E. Schultz, Woodbury, MN (US); Michael L. Parham, Marine on St. Croix, MN (US); Andrew R. Fox, Oakdale, MN (US)

(21) Appl. No.: 19/474,401

(22) PCT Filed: Apr. 12, 2024
(86) PCT No.: PCT/IB2024/053610

§ 371 Date: Oct. 10, 2025

Related U.S. Application Data
(60) Provisional application No. 63/496,003, filed on Apr. 13, 2023.
(60) Provisional application No. 63/607,197, filed on Dec. 7, 2023.

(51) Int. Cl. B01D 39/16

(52) U.S. Cl. CPC B01D 39/163; B01D 2239/0618; B01D 2239/065; B01D 2239/069; B01D 2239/1233; B01D 2239/1291

(57) ABSTRACT

A filter media is presented that includes a first layer comprising a first plurality of fibers. The first plurality of fibers are characterized by an average diameter of less than or equal to about 50 microns, a thickness greater than or equal to about 1.7 mm, and a basis weight of greater than or equal to about 90 gsm. The first layer has an initial NaCl efficiency of less than or equal to about 75% at 14 cm/s face velocity. The filter media also includes a second layer having a second plurality of fibers, the second plurality of fibers being characterized by an average diameter of greater than or equal to 8 microns. The second layer has an initial NaCl efficiency of greater than or equal to about 75% at 14 cm/s face velocity.

### TECHNICAL FIELD

Improved gradient filter media for filtration applications are described, along with methods of making the same. The filter media have high loading capacity, low pressure drop and high efficiency for particulate filtering.

### SUMMARY

There is a desire to identify a filter media which has improved loading and/or reduced pressure drop. Such filter media may be useful for a variety of applications, including respiratory protection devices, furnace filters, Heating, ventilation, and air conditioning (HVAC) filters, air conditioning filters and/or portable air purifiers or fans.

A filter media is presented that includes a first layer comprising a first plurality of fibers. The first plurality of fibers are characterized by an average diameter of less than or equal to about 50 microns, a thickness greater than or equal to about 1.7 mm, and a basis weight of greater than or equal to about 90 gsm. The first layer has an initial NaCl efficiency of less than or equal to about 75% at 14 cm/s face velocity. The filter media also includes a second layer having a second plurality of fibers, the second plurality of fibers being characterized by an average diameter of greater than or equal to 8 microns. The second layer has an initial NaCl efficiency of greater than or equal to about 75% at 14 cm/s face velocity.

The above summary is not intended to describe each embodiment. The details of one or more embodiments of the invention are also set forth in the description below. Other features, objects, and advantages will be apparent from the description and from the claims.

### BRIEF DESCRIPTION OF THE DRAWINGS

FIGS. 1A to 1C-6 illustrate respiratory protection devices that may benefit from embodiments herein.

FIG. 2 is a schematic representation showing shirred filter media that may be used in embodiments herein.

FIG. 3 is a schematic representation of a cross section of shirred filter media, showing its construction.

FIG. 4 is a schematic representation of making a shirred filter media according to one embodiment of the present disclosure.

FIGS. 5A-5B illustrates a schematic representation of a cutaway view of a filter for a respiratory protection device in accordance with embodiments herein.

FIGS. 6A-1 to 6B-2 illustrate some example embodiments of the present invention.

FIG. 7 illustrates a method of making a filter for a respiratory protection device in accordance with some embodiments herein.

FIGS. 8A-8D illustrates a filter cartridge in accordance with some embodiments herein.

FIG. 9 illustrates a room air purifying device in accordance with some embodiments herein.

FIGS. 10A-10D illustrate different furnace filter configurations in accordance with some embodiments herein.

FIGS. 11A-11B illustrate a cross-sectional view of a filter in accordance with some embodiments herein.

### DETAILED DESCRIPTION

As used herein, the terms:

“a”, “an”, and “the” are used interchangeably and mean one or more; and “and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

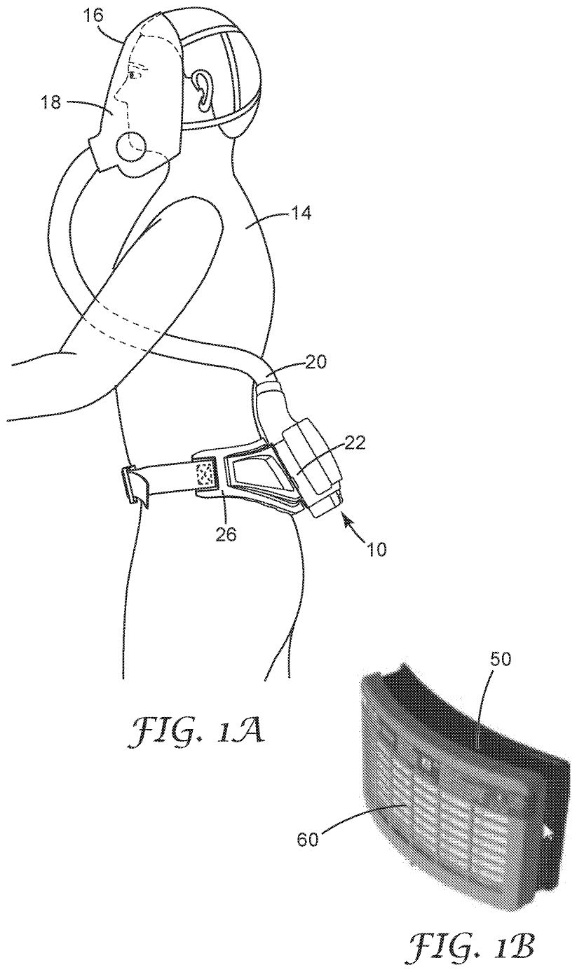

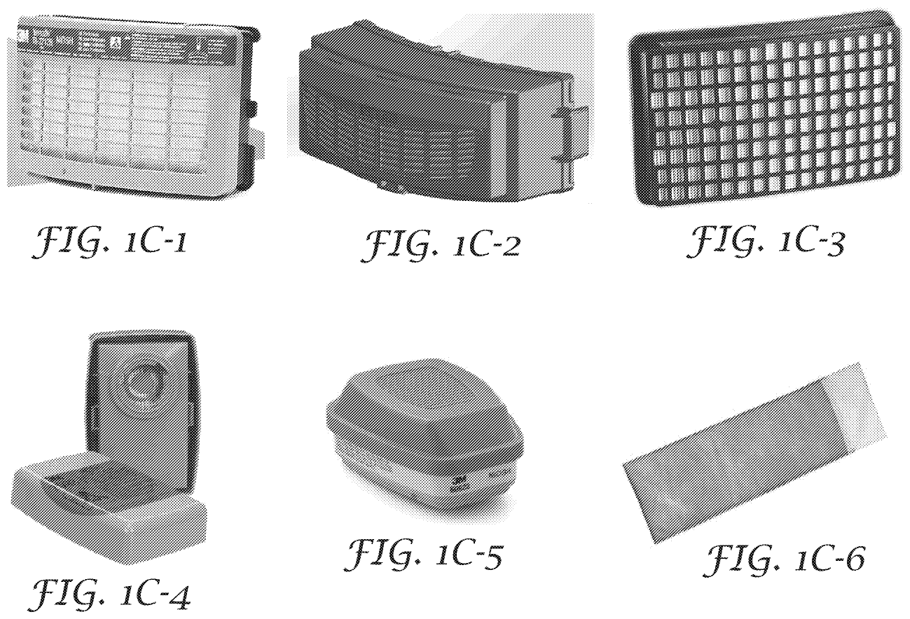

FIGS. 1A-1C illustrate respiratory protection devices that may benefit from embodiments herein. Respiratory protection devices, as used herein, can include both disposable devices, such as single-use disposable respirators (DR, e.g.), reusable respirators (e.g. RR-respirators having a half or full elastomeric facepiece and/or replaceable filters), hybrid DR-RR products (e.g. particulate respirator model numbers 8825+ or 8835+, available from 3M Company) as well as Powered Air Purifying Respirators (e.g., PAPRs), prefilters or other components for any of the said respirators, or other devices including said respirators. However, it is expressly contemplated that filter media described herein may be used in all above types of respiratory protection devices. Additionally, while respiratory devices are described herein as one example where embodiments herein may be useful, it is also expressly contemplated that filter media herein may also be useful for other filter applications, including furnace filters, air conditioner filters, room air purifiers or other suitable applications.

Depth loading filters could be used in reusable respirators, those typically consisting of an elastomeric facepiece with permanent or replaceable cartridges or filters. These can be used for respiratory protection from particulates as well as gasses and vapors. Filters for protection from particulate environments can be either a straight particulate filter or a particulate filter ahead of a gas and vapor cartridge (where protection from gases and vapors is also desired). In these uses, products currently range from flat pancake style filters such as the 3M® 2091 (Available from 3M Company) filter to pleated packs found on filters such as the 3MR 7093 or the 3M® 60926 (both available from 3M Company). Additionally, in some applications such as spray painting, a prefilter can be added onto a gas filter such as a 3M® 5N11 being placed in front of a 3M® 6001 filter using a 3M® 501 retainer to provide replaceable particulate filtration to that of a gas and vapor only 6001 cartridge (all available from 3M Company). Depth loading filters could be used in any of these applications, as well as any other suitable applications or respirator models to increase the loading capability, reduce the pressure drop (ie breathing resistance) for a given loading, and/or simplify the construction of the filter.

FIG. 1A illustrates a PAPR 10 being worn by a user 14. PAPR 10 comprises breathing head gear 16 shown disposed on the face of the user 14 creating a breathing space 18 in which filtered air is supplied through a breathing tube 20 for the user to inspire and into which the user can exhale. Breathing head gear 16 may be a breathing mask, hood, helmet, hard head-top, or other suitable component having an inlet for filtered air defining a breathing space 18 for the user. PAPR 10 includes a blower/filter unit 22 that is typically attached to the user 14 via a belt 26 secured about the waist of the user 14. Blower/filter unit 22 is designed to be worn by a user in an atmosphere having unwanted respiratory (and potentially other) contaminants.

Within blower/filter unit 22 is a replaceable filter housing 50 that contains a filter medium 60. Filter medium 60 is designed such that, as air passes through it (e.g. using a blower), particulates, and chemical gases and/or vapors are filtered out. Filter medium 60 needs to be exchanged periodically, as the filter capacity is not infinite.

It is desired to have filters with larger capacity and lower pressure drop for longer use times and/or user comfort, and high efficiency to pass regulatory standards.

One of the most common practices to balance these design aspects is to use larger surface areas of filter media in pleated format. FIGS. 1C-1-1C-5 illustrate different examples of pleated media packs used in respirators, and FIG. 1C-6 illustrates a flash sheet filter for a PAPR. The pleated media pack provides better filtration performance than flat media but leads to thicker and bulkier configuration that takes up more space in a filter device for a PAPR. As blower/filter 22 has to be worn by a PAPR user, there is a limit on bulk and weight that is practically acceptable. Additionally, pleated media requires sealing a pleat pack against a filter frame, which presents manufacturing challenges. Additionally, pleat packs do not conform well to curved surface or irregular shapes, requiring boxy and/or bulky designs. FIGS. 1C-1 and 1C-6 are provided for illustration only, it is expressly contemplated that filter media described herein may be useful for other applications where filter media is used in a cartridge.

The other common practice is to use larger area of media in flat format to help reduce pressure drop. For example, the Powered Air Purifying Respirator (PAPR) Airstream by 3M uses a large bag filter as shown in FIG. 1C-6. It is common to have a total media area more than 600 cm², more than 700 cm², or even higher area for PAPR filters in flat format. The large flat media is typically configured in curved or irregular shapes in a filter device for better form factor and requires clearance around them so that all surface area of media is exposed to air flow and used. That leads to bulkier designs. In addition, large flat sheet lacks mechanical strength to support itself so a supporting structure is likely required, which again contributes to bulkier filters.

Therefore, there is a need for a high-performance particulate depth loading media that may provide comparable filtration performance to pleated pack or larger piece of conventional media with a more compact footprint.

There is a desire to improve filters-improve particulate loading capacity and pressure drop at an acceptable filtration efficiency with ease of use. Embodiments herein relates to high-performance particulate depth loading filtration media. Filters in embodiments herein are multilayer composites with at least two layers of different filter media, as described below. Filter media in the different layers may vary in a number of different parameters from one another. For example, the first layer may be composed of a different material than the second layer. Alternatively, or additionally, the first layer may have a different fiber size and/or basis weight and/or solidity. Alternatively, or additionally, the first layer may be a different type of non-woven material (e.g. spunbond vs. meltblown). Alternatively, or additionally, the first layer may be composed of the same material, but have more surface area per unit of filter area (e.g. square inch or square centimeter). The first and second layers may differ in other ways. Additionally, in some embodiments a third layer of filter media is present, which may differ from both the first and second layer in any of the parameters described above.

The multilayer composite filters described in embodiments herein enable high particulate loading capacity, high filtration efficiency, and low pressure drop, which are highly desired but difficult to achieve due to the competing nature of those performance attributes in conventional filtration media. For example, increasing loading capacity can be achieved by adding additional layers of filter media, which generally increases a pressure drop.

Each of the layers in filters herein may operate as a different functional zone of the filter as a whole. For example, an upstream or inlet layer (e.g. a first layer that air passing through the filter encounters) may be composed of one layer of media designed primarily for high particulate loading. An inner layer may be composed of one media designed primarily for high efficiency (e.g. capturing a high percentage of all particulates passing therethrough). Some embodiments may have one or more transition layers designed for a combination of high-loading-capacity and high efficiency.

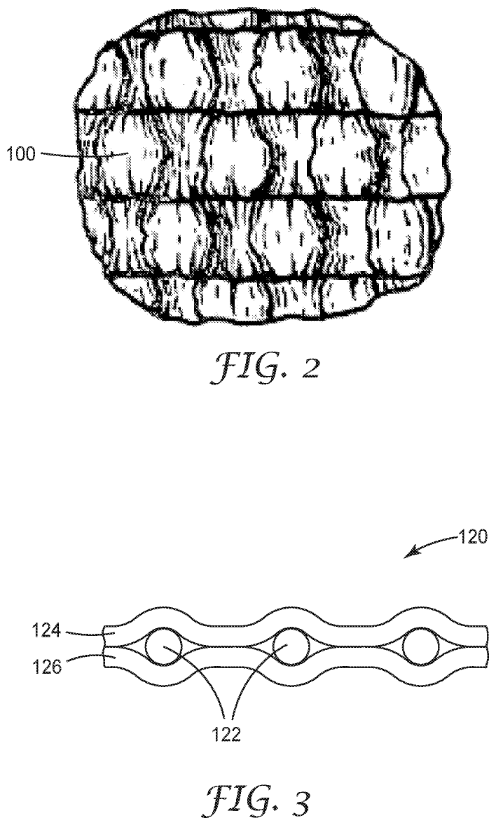

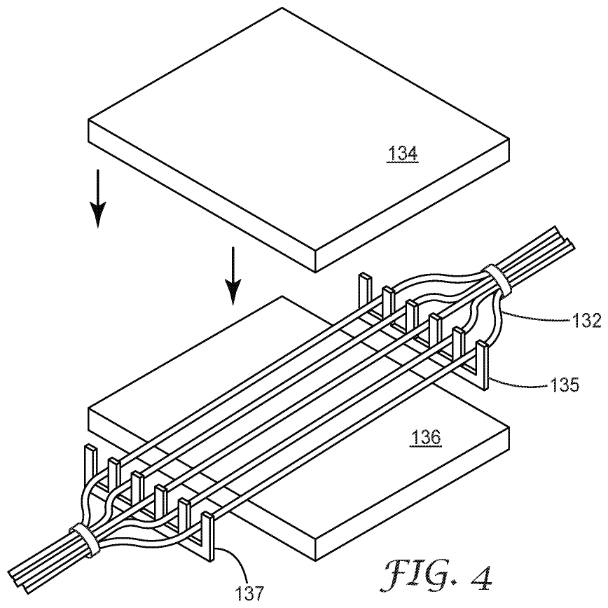

Embodiments herein may utilize shirred media in one or more layers of a composite filter. FIGS. 2-4 illustrate and describe a method of making shirred filter media. Additional details on shirred media construction can be found in U.S. Provisional Patent Application 63/434,365, filed Dec. 21, 2022. “Shirred media” and “wrinkled media” are terms used herein to refer to a media that has undergone a wrinkling process, for example as described with respect to FIGS. 3-4. However, it is expressly contemplated that other suitable methods may be used to make wrinkled, or shirred, media.

Shown in FIG. 2 is an example of a shirred, or wrinkled, filter media of the present disclosure. Wrinkled filter media 100 comprises a plurality of elastic filaments that are spaced apart. The plurality of elastic filaments are sandwiched between two adhesive-coated non-woven porous fibrous webs. During fabrication of the shirred filter media (herein referred to as “media”), the elastic filaments are pulled under tension, such that when the tension is released, the non-woven porous fibrous webs become puckered. Shown in FIG. 2 is a side view showing a first non-woven porous fibrous web 124 and a second non-woven porous fibrous web 126, with elastic filament 122 positioned therebetween. FIG. 2 shows that first non-woven porous fibrous web 124 is in direct contact with second non-woven porous fibrous web 126. Images of actual wrinkled articles made according to the present disclosure are shown in FIGS. 4-6 and 7A and 7B of U.S. Provisional Patent Application 63/434,365, filed Dec. 21, 2022. Based on the resulting articles, it is believed that when adhesive is used, the adhesive bonds the two non-woven porous fibrous webs together with the filaments therebetween. It is assumed that the bonding of the first and second non-woven porous fibrous webs is discontinuous and that the non-woven porous fibrous web(s) may not be bonded (for example, adhesively bonded) to the filament along the length of the filament.

In accordance with some embodiments herein, one or more of the nonwoven porous fibrous webs are formed of fibers having a discrete length.

### Material Table-Adhesives, Elastic Filaments, Testing Aerosols

TABLE 1
Materials used in making and testing composite depth media

| Name | Source |
|---|---|
| Adhesive | Spray adhesive available under the trade designation “3M Super 77 |
| | Multipurpose Adhesive” by 3M Co., Maplewood, MN, USA |
| Adhesive | Bostik HM-9041, available from Bostik Incorporate, 11320 Watertown Plank |
| | Rd., Wauwatosa, WI 53226-3413 |
| filament | Spandex fibers rolled on a spool, available under the trade designation “100% |
| | Lycra Spandex 235 Multifil”, DTEX Type 737, 210 denier from Invista |
| | Company, Wichita, Kansas. |
| Silica | Fine ground silica particles, grade Sil-Co-Sil 40, available from U.S. Silica |
| | Company, 8490 Progress Drive, Frederick, MD 21701. Ussilica.com |
| NaCl | Sodium chloride ACS regent grade NaCl 2 wt % solution in deionized water. |
| DOP | Dioctyl Phthalate, Sigma Aldrich |

### Material Table-Nonwoven Media

TABLE 2
Nonwoven webs used in composite depth media

| Media | | | |
|---|---|---|---|
| ID | Media Material | Source | Properties |
| F1 | Polypropylene | A non-woven meltblown fibrous | Having a basis weight of 44 |
| | | web having fibers with a charging | gsm, a thickness of 0.018 in |
| | | additive package as described in | (0.45 mm), and an effective fiber |
| | | U.S. Pat. No. 10,724,171 | diameter of 5 micrometers. |
| | | (Schultz et al.), which | |
| | | can be prepared per Process A and | |
| | | Charging Method 3 as disclosed in | |
| | | U.S. Pat. No. 10,724,171. | |
| F2 | Polypropylene | A non-woven meltblown fibrous | Having a basis weight of 61 |
| | | web having fibers with a charging | gsm, a thickness of 0.035 in |
| | | additive package as described in | (0.88 mm), and an effective fiber |
| | | U.S. Pat. No. 10,724,171, | diameter of 7.5 micrometers. |
| | | which can be prepared | |
| | | per Process A and Charging | |
| | | Method 3 as disclosed in | |
| | | U.S. Pat. No. 10,724,171. | |
| F3 | Polypropylene | A non-woven meltblown fibrous | Having a basis weight of 61 |
| | | web having fibers with a charging | gsm, a thickness of 0.036 in |
| | | additive package as described in | (0.90 mm), and an effective fiber |
| | | U.S. Pat. No. 10,724,171, | diameter of 12.5 micrometers. |
| | | which can be prepared | |
| | | per Process A and Charging | |
| | | Method 3 as disclosed in | |
| | | U.S. Pat. No. 10,724,171. | |
| F4 | Polypropylene | A non-woven meltblown fibrous | Having a basis weight of 18 |
| | | web having fibers with a charging | gsm, a thickness of 0.008 in |
| | | additive package as described in | (0.19 mm), and an effective fiber |
| | | U.S. Pat. No. 10,724,171, | diameter of 7.0 micrometers. |
| | | which can be prepared | |
| | | per Process A and Charging | |
| | | Method 3 as disclosed in | |
| | | U.S. Pat. No. 10,724,171. | |
| F5 | Polypropylene | A non-woven fibrillated film media | Having a basis weight of |
| | | prepared per procedures disclosed | approximately 150 gsm, |
| | | in U.S. Pat. No. 3,998,916 and | thickness of 3.9 mm, and a |
| | | U.S. Pat. No. 4,178,157 | rectangular cross section of |
| | | | approximately 10 μm × 40 μm |
| | | | and a length of approximately 90 |
| | | | mm. |
| F6 | Polypropylene | A non-woven fibrillated film media | Having a basis weight of |
| | | prepared per procedures disclosed | approximately 90 gsm, thickness |
| | | in U.S. Pat. No. 3,998,916 and | of 1.8 mm, and a rectangular |
| | | U.S. Pat. No. 4,178,157 | cross section of approximately |
| | | | 10 μm × 40 μm and a length of |
| | | | approximately 90 mm. |
| F7 | Polypropylene | A non-woven fibrillated film media | Having a basis weight of |
| | | prepared per procedures disclosed | approximately 70 gsm, thickness |
| | | in U.S. Pat. No. 3,998,916 and | of 1.6 mm, and a rectangular |
| | | U.S. Pat. No. 4,178,157 | cross section of approximately |
| | | | 10 μm × 40 μm and a length of |
| | | | approximately 90 mm. |
| F8 | Polypropylene | A non-woven fibrillated film media | Having a basis weight of |
| | | prepared per procedures disclosed | approximately 50 gsm, thickness |
| | | in U.S. Pat. No. 3,998,916 and | of 1.1 mm, and a rectangular |
| | | U.S. Pat. No. 4,178,157 | cross section of approximately |
| | | | 10 μm × 40 μm and a length of |
| | | | approximately 90 mm. |
| F9 | Polypropylene | A spunbond non-woven media | Having a basis weight of 65 |
| | | prepared as described below | gsm, a thickness of 0.038 in |
| | | | (0.97 mm), and an effective fiber |
| | | | diameter of approximately 23 |
| | | | micrometers |
| F10 | Polypropylene | A high loft Spunbond non-woven | Having a basis weight of 45 |
| | | media, prepared as described below | gsm, a thickness of 0.034 in |
| | | | (0.86 mm), and an effective fiber |
| | | | diameter of approximately 28 |
| | | | micrometers |

### Elastic Filaments

The filaments of the present application comprise a polymer and are elastic in nature, meaning that the filament is capable of recovering or at least partially recovering in length following stretching. Exemplary types of polymeric materials that may be used for filaments of the present application include: natural rubber, polyether-polyurethanes, polyamides, polyisoprenes, copolymers of isoprene and neoprene, polymers of 2-chloro-1,3-butadiene, polyether-polyurea copolymer (e.g., Lycra), polyurethane (e.g., spandex).

In one embodiment, the filaments have an average diameter of at least 1, 5, 10, or even 20 micrometers and at most 25, 50, 100, 200, 400, 600, 800, 1000, 1200 micrometers. In one embodiment, the filaments have a denier of at least 100, 150, 175, 200, 210, 220, 250, or even 500. In one embodiment, the filaments have a denier of at most 1200, 900, 800, 700, 600, 500, 400, 350, 300, 250, or even 225 denier.

### Non-Woven Porous Fibrous Web

The plurality of elastic filaments is positioned between two non-woven porous fibrous webs, herein referred to as a non-woven web. The nonwoven webs of the present disclosure can be made by wet laid, carded, air laid, spunlaced, spunbonding, spunmelt, or melt-blowing techniques or combinations thereof. The nonwoven webs herein may also be formed of fibrillated film. The nonwoven webs herein may also be formed of fibrillated film (USRE32171-Method for the manufacture of an electret fibrous filter). In some embodiments, a nonwoven web may undergo a relofting step after formation to increase loftiness. The nonwoven webs may also include or be composed of a scrim or netting. The nonwoven webs may comprise nanofibers produce by electrospinning processes or another suitable process. Spunbonded fibers are formed by extruding molten thermoplastic polymer as filaments from a plurality of fine, usually circular capillaries of a spinneret with the diameter of the extruded fibers being rapidly reduced. Meltblown fibers are typically formed by extruding the molten thermoplastic material through a plurality of fine, usually circular or square, die capillaries as molten threads or filaments into a high velocity, usually heated gas (e.g., air) stream which attenuates the filaments of molten thermoplastic material to reduce their diameter. Thereafter, the meltblown fibers are carried by the high velocity gas stream and are deposited on a collecting surface to from a web of randomly dispersed meltblown fibers. Any of the non-woven webs may be made from a single type of fiber or two or more fibers that differ in the type of thermoplastic polymer and/or thickness.

The relofted spunbond or ultra high loft (UHL) filter nonwoven materials were prepared as follows. Loftiness can be described in terms of solidity. “Solidity” is a nonwoven web property inversely related to density and characteristic of web permeability and porosity (low Solidity corresponds to high permeability and high porosity), and is defined by Equation 1 below.

$$Solidity ( \% ) = \frac{Web Basis Weight ( \frac{g}{{m}^{2}} )}{\begin{matrix}10 * Web Thickness ( mm ) * \\ Fiber Polymer Density ( \frac{g}{{cm}^{3}} )\end{matrix}} \qquad Equation 1$$

Some embodiments herein have a solidity of less than 12%. Some embodiments herein have a solidity of less than 10%. Some embodiments herein have a solidity of less than 8%. Some embodiments herein have a solidity of less than 6%. Some embodiments herein have a solidity of less than 4%.

Continuously extruded meltspun fibers were made and collected in general accordance with the procedures described in the Examples of U.S. Pat. No. 8,240,484, which are incorporated herein by reference. The collected fibers were autogenously bonded to form self-supporting, spunbonded webs in general accordance with the procedures described in U.S. Pat. No. 9,976,771, incorporated herein by reference, and were area-bonded using calendering methods of the general manner described in the '484 patent. The area-bonds were estimated to be present at an area percentage of the web of approximately 1.5-1.6%. The webs were hydrocharged in general accordance with the procedures disclosed in U.S. Pat. No. 8,790,449, incorporated herein by reference. The flat-web samples exhibited a basis weight of approximately 55 grams per square meter (g/m2).

The flat-web samples were then relofted by needle-punching. The needles were provided (in a topside-punching arrangement including a top hole-board and a bottom hole-board with approximately 50 mm vertical spacing therebetween) in 32 rows, each row extending across an 85 cm lateral (crossweb) width with the rows being spaced along a 28.5 cm downweb extent. Each row had 104 needles (the within-row needle spacing was thus approximately 8 mm). The needles were of the general type available under the trade designation 609831 15×18×25×3 ½ R333 G 3007, from GROZ-BECKERT, Albstadt, Germany. The web was passed through the needle-puncher in a continuous manner at a speed of around 10 meters per minute. As the web passed through the needle-punching unit it was needle-punched at a rate of approximately 350 strokes per minute. From these parameters it was estimated that the web was punched at a density of approximately 25 punches per square centimeter of web material. The punching was performed from one side (the top side) only.

The increase in loft of the web was notably evident even upon casual visual inspection. That is, the relofted web was noticeably thicker and “fuzzier” than the as-received web, and very few of the area-bonded areas were still visible; rather, they seemed to be obscured by fibers that were overlying them. The relofted web exhibited a very uniform appearance and had an effective fiber diameter (EFD) of 28 μm and a solidity of 3.9%. Suitable thermoplastic polymeric materials include, but are not limited to, polyolefins (such as polypropylene, or polyethylene), poly(isoprenes), poly(butadienes), fluorinated polymers, chlorinated polymers, polyamides, polyimides, polyethers, poly(ether sulfones), poly(sulfones), poly(vinyl acetates), polyesters such as poly(lactic acid), copolymers of vinyl acetate, such as poly(ethylene)-co-poly(vinyl alcohol), poly(phosphazenes), poly(vinyl esters), poly(vinyl ethers), poly(vinyl alcohols), and poly(carbonates).

Suitable polyolefins include, but are not limited to, poly(ethylene), poly(propylene), poly(1-butene), poly-4-methyl-1-butene, copolymers of ethylene and propylene, alpha olefin copolymers (such as copolymers of ethylene or propylene with 1-butene, 1-hexene, 1-octene, and 1-decene), poly(ethylene-co-1-butene), poly(4-methyl-1-pentene) and poly(ethylene-co-1-butene-co-1-hexene).

Suitable polyamides include, but are not limited to, typical nylon polymers such as poly(iminoadipoyliminohexamethylene), poly(iminoadipoyliminodecamethylene), and polycaprolactam. Suitable polyimides include, but are not limited to, poly(pyromellitimide).

Suitable poly(ether sulfones) include, but are not limited to, poly(diphenylether sulfone) and poly(diphenylsulfone-co-diphenylene oxide sulfone).

Suitable copolymers of vinyl acetate include, but are not limited to, poly(ethylene-co-vinyl acetate) and such copolymers in which at least some of the acetate groups have been hydrolyzed to afford various poly(vinyl alcohols).

The fibers selected for the non-woven web depend upon the kind of particulate to be filtered. Particularly useful fibers include webs of melt-blown fibers, such as those disclosed in Wente, Van A., “Superfine Thermoplastic Fibers”, 48 Industrial Engineering Chemistry, 1342 et seq (1956). Webs of meltblown fibers provide especially good filtration layers when used in a persistent electrically charged form (see U.S. Pat. No. 4,215,682 to Kubik et al). Preferably, these melt-blown fibers are microfibers having an effective diameter of at least 4, 6, 8 or even 10 micrometers and at most 12, 14, 16 or even 20 micrometers. Other particularly useful filtration fibers are electrically-charged-fibrillated-film-fibers as disclosed in U.S. Pat. No. RE 31,285 to Van Turnhout. Rosin wool fibrous webs and webs of glass fibers are also useful, as are solution spun, or electrostatically sprayed fibers, especially in microfiber form.

In some embodiments, larger fibers are used. For example, in some embodiments, fibers having an effective diameter less than about 50 μm are used to form wrinkled media. In some embodiments, fibers having an effective diameter less than about 40 μm are used to form wrinkled media. In some embodiments, fibers having an effective diameter less than about 35 μm are used to form wrinkled media. In some embodiments, fibers having an effective diameter less than about 30 μm are used to form wrinkled media. In some embodiments, fibers having an effective diameter less than about 25 μm are used to form wrinkled media.

The non-woven webs are porous, meaning that the outside surface of one side of the non-woven web is in fluid communication with the outside surface on the opposing side of the same non-woven web. This ensures flow of vaporous fluids, air, or liquids through the non-woven web. The non-woven webs are coextensive meaning that the web is a complete, continuous layer of non-woven material with no rips or tears.

In one embodiment, at least one of the non-woven webs of the present disclosure comprises electret fibers. Electrets are a dielectric material that possess a quasi-permanent electric charge or dipole polarization. Electrets typically are improved by incorporating a charging additive into a polymeric material and then inducing a charge onto the polymeric materials using a corona treatment, a tribocharging treatment, a hydrocharging treatment, or combinations thereof. In one embodiment, the electret fibers are monocomponent fibers. In another embodiment, the electret fibers are bicomponent fibers, such as sheath-core, side-by-side, etc. In one embodiment, the electret fibers are sheath-core fibers comprising a core having a coextensive sheath layer disposed thereon. In one embodiment, the core comprises an electrostatic charge enhancing additive. In one embodiment, the sheath comprises an electrostatic charge enhancing additive. In one embodiment, the electret fibers are side-by-side, wherein the fiber comprises two components lying next to each other along the length of the fiber. In one embodiment, the electret fibers are so called “islands-in-the-sea” extrudates, wherein multiple fiber cores (i.e., more than 1, 2, 4, or even 6 cores) are distributed within a polymer matrix, which also forms the sheath.

Many charge enhancing additives for making electret-containing fiber webs are known in the art. Exemplary electrostatic charge enhancing additives may include pigments, light stabilizers, primary and secondary antioxidants, metal deactivators, hindered amines, hindered phenols, metal salts, phosphite triesters, phosphoric acid salts, fluorine-containing compounds, and combinations thereof. Preferably, the charge enhancing additive is a solid at ambient conditions to prevent migration within the resin and does not decompose at moderate temperatures. In one embodiment, the charge enhancing additive is a solid at temperatures of at least 25, 30, 40, 50, 60, 80 or even 100° C. In one embodiment, the charge enhancing additive does not decompose, for example, there is no significant weight loss (i.e., less than 5, 1, or even 0.1 wt %) when measured under nitrogen by thermogravometric analysis using a ramp rate of 10° C./min to heat up to 235° C.

Particularly preferred change enhancing additives include hindered amine-based additives, triazine-based additives, and hindered phenol-based additives.

Specific examples of the hindered amine-based or triazine-based additives include (poly[[6-(1,1,3,3,-tetramethylbutyl)amino]-s-triazine-2,4-diyl] [[(2,2,6,6-tetramethyl-4-piperidyl) imino] hexamethylene [(2,2,6,6-tetramethyl-4-piperidyl) imino]]), available under the trade designation “CHIMASSORB 944” from BASF, Ludwigshafen, Germany; dimethyl succinate-1-(2-hydroxyethyl)-4-hydroxy-2,2,6,6-tetramethylpiperidine polycondensate, available under the trade designation “TINUVIN 622” from BASF; di-tert-butyl-4-hydroxybenzyl)-2-n-butyl malonate bis(1,2,2,6,6-pentamethyl-4-piperidyl available under the trade designation “TINUVIN 144” from BASF; a polycondensate of dibutylamine-1,3,5-triazine-N,N′-bis(2,2,6,6-tetramethyl-4-piperidyl-1,6-hexamethylenediamine-N-(2,2,6,6-tetramethyl-4-piperidyl)butylamine, available under the trade designation “CHIMASSORB 2020” from BASF; 2-(4,6-diphenyl-1,3,5-triazin-2-yl)-5-((hexyl)oxy)-phenol, available under the trade designation “TINUVIN 1577” from BASF; N-substituted amino aromatic compounds, particularly tri-amino substituted compounds, such as 2,4,6-trianilino-p-(carbo-2′-ethylhexyl-l′-oxy)-1,3,5-triazine, available under the trade designation “UVINUL T-150” from BASF; and 2,4,6-tris-(octadecylamino)triazine, also known as tristearyl melamine (“TSM”).

Hindered phenol-based additives having a hydroxyl group as the terminal functional group. he hindered phenol-based additives are not particularly limited, and specific examples include pentaerythrityl-tetrakis[3-(3,5-di-tert-butyl-4-hydroxyphenyl) propionate] (Irganox 1010, manufactured by BASF), octadecyl-3-(3,5-di-tert-butyl-4-hydroxyphenyl) propionate (Irganox 1076, manufactured by BASF), tris-(3,5-di-tert-butyl-4-hydroxybenzyl)-isocyanurate (Irganox 3114, manufactured by BASF), 3,9-bis-{2-[3-(3-tert-butyl-4-hydroxy-5-methylphenyl)-propionyloxy]-1,1-dimethylethyl}-2,4,8,10-tetraoxaspiro-[5,5]undecane (Sumilizer-GA-80, manufactured by Sumitomo Chemical Co., Ltd.), and the like.

Additional thermally stable organic triazine compounds or oligomers, which compounds or oligomers contain at least one nitrogen atom in addition to those in the triazine ring, are disclosed in U.S. Pat. Nos. 6,268,495, 5,976,208, 5,968,635, 5,919,847, and 5,908,598 to Rousseau et al.

Further examples of charge-enhancing additives are provided in U. S. Publ. No. 2011/0137082 (Li et al.). U.S. Pat. No. 8,613,795 (Li et al.), U.S. Pat. No. 7,390,351 (Leir et al.), U.S. Pat. No. 5,057,710 (Nishiura et al.), and U.S. Pat. Nos. 4,652,282 and 4,789,504, both to Susumu et al., and U.S. Pat. No. 8,790,449 B2 (Li et al.).

The charge-enhancing additive(s) can be added in any suitable amount. The charge-enhancing additives of this disclosure may be effective even in relatively small quantities. Typically, the charge-enhancing additive is present in a thermoplastic resin and charge-enhancing additive blend in amounts of up to about 10% by weight, more typically in the range of 0.02 to 5% by weight based upon the total weight of the blend. In some embodiments, the charge-enhancing additive is present in an amount ranging from 0.1 to 3% by weight, 0.1 to 2% by weight, 0.2 to 1.0% by weight, or 0.25 to 0.5% by weight.

Membrane and Non-Woven Porous Web with Sorbent

Alternatively or additionally, porous membrane may be used in place of, and/or combined with the non-woven fibrous web. A wrinkled membrane may be wrinkled, for example, using the techniques described herein above with respect to FIGS. 1-2. The plurality of elastic filaments is positioned between a membrane layer and one or more non-woven porous webs. The membrane layer may include membrane and one or more non-woven webs stacked or laminated or bonded. Alternatively or additional, non-woven porous web may comprise of a sorbent material. The sorbent particles may be disposed on the surface of non-woven web or throughout the depth of non-woven web. One example of the sorbent material is activated carbon. Other sorbent materials such as polymeric sorbent may be used as well.

Table 2 lists the nonwoven webs with their initial pressure drops (dP) and percent penetration in NaCl and DO tests. A minimum of two single sheets of each of the flat non-woven media web were measured.

In some embodiments herein, an initial pressure drop of filter media is less than 20 mm H₂O at 14 cm/s face velocity. In some embodiments, an initial pressure drop of the filter media is less than 10 mm H₂O. In some embodiments, an initial pressure drop of the filter media is less than 8 mm H₂O. In some embodiments, an initial pressure drop of the filter media is less than 6 mm H₂O. In some embodiments, an initial pressure drop of the filter media is less than 4 mm H₂O. In some embodiments, an initial pressure drop of the filter media is less than 2.0 mm H₂O. In some embodiments, an initial pressure drop of the filter media is less than 1.0 mm H₂O.

TABLE 3
Flat nonwoven webs' initial dP and penetration in NaCl and DOP tests

| | Samples of Flat Nonwoven Media webs | | | | | | |
|---|---|---|---|---|---|---|---|
| | | NaCl test at 13.9 cm/s | | | DOP test at 13.9 cm/s | | |
| Media | | Initial dP | Initial | | Initial dP | Initial | |
| ID. | Media | (mmH₂O) | Pen | QF | (mmH₂O) | Pen | QF |
| F1 | Meltblown 5 μm | 12.9 | 0.01% | 0.73 | — | — | — |
| F2 | Meltblown 7.5 μm | 6.8 | 0.17% | 0.94 | — | — | — |
| F3 | Meltblown 12.5 μm | 3.4 | 4.7% | 0.91 | — | — | — |
| F4 | Meltblown 7 um | 2.6 | 10.6% | 0.88 | — | — | — |
| F5 | Fibrillated Film GSU 150 | 2.6 | 3.7% | 1.3 | — | — | — |
| F6 | Fibrillated film GSU 90 | 1.3 | 17% | 1.4 | — | — | — |
| F7 | Fibrillated film GSU 70 | 1.2 | 18.4% | 1.5 | — | — | — |
| F8 | Fibrillated film GSU 50 | 0.9 | 29.6% | 1.4 | — | — | — |
| F9 | Spunbond HL 85 | — | — | — | 0.65 | 50% | 1.07 |
| F10 | UHL | — | — | — | 0.23 | 63% | 2.01 |

### Method of Making Wrinkled Media

In one embodiment, the wrinkled filter media of the present application can be made by stretching a plurality of elastic filaments 132. The filaments are not generally bonded to one another (for example, the filaments of the present disclosure are not a scrim). The plurality of elastic filaments 132 in the first series are held (for example using a spacer 135, 137) such that each of the filaments is substantially parallel to one another and are spaced a given distance apart. Generally, the substantially parallel filaments should not touch the nearest neighbor filament in the working portion of the finished good. In one embodiment, the elastic filaments are held with a spacing of at least 2, 4, 5, or even 6 filaments per inch. In one embodiment, the elastic filaments are held with a spacing of at most 8, 10, 12, 15, 20, or even 25 filaments per inch. Generally, the spacing of the filaments is selected to achieve the desired shirring of the non-woven web without causing a large change in pressure.

The filaments 132 can be stretched to a desired length preferably before it reaches its elastic limit or yield point. The % stretch as used herein is defined as the difference between the length of the stretched filament and the length of the relaxed filament divided by the length of the relaxed filament converted to a percent. In one embodiment, the elastic filaments are stretched to greater than 50, 75, 100, 150, 200, 250 or even 300%. The filaments can be stretched more than 250% so long as the filaments do not go beyond the elastic limit to deformation or break during the manufacturing of the shirred media disclosed herein.

The first and second non-woven webs 134, 136 are positioned on either side of the stretched filaments. The first and second non-woven webs may be the same or different. The non-woven webs are selected based on the desired performance properties. The non-woven webs selected may be different in terms of composition, basis weight, fiber diameter, thickness, porosity, etc.

The first and second non-woven webs 134, 136 are bonded directly together such that the first non-woven web 134 contacts the second non-woven web 136, optionally with the use of an adhesive as exemplified below. In one embodiment, an adhesive is used to directly bond (or adhere) the first and second non-woven webs together. Such adhesives can include a pressure sensitive adhesive or a hot melt adhesive. Pressure sensitive adhesives are known in the art and are generally adhesives that can adhere based on room temperature conditions when pressure (e.g., finger pressure) is applied. Exemplary pressure sensitive adhesives include: a natural latex or synthetic polymer such as a (meth)acrylate. A commercially available pressure sensitive adhesive includes a spray adhesive available under the trade designation “3M Super 77 Multipurpose Adhesive” by 3M Co., Maplewood, MN, USA. Hot melt adhesives are those adhesives that are thermoplastic polymers which are heated above their softening point and when applied in their softened state to a surface, penetrate the surface and solidify ensuring cohesion. Exemplary hot melt adhesives include: Bostik HM-9041 available from Bostik inc., Wauwatosa, WI, and Tailored HM011BA available from Tailored Chemical Products Inc., Hickory, NC. In the embodiments of the present application when an adhesive is applied, the weight of adhesive used per unit area is less than the weight per unit area of the non-woven web. In one embodiment, the weight per unit area of the adhesive is less than 0.5, 0.4, 0.3, 0.2, or even 0.1% of the weight per unit area of the non-woven porous fibrous webs in the article. Ideally, the adhesive should not interfere with the performance of the article and should be collapsible, meaning that the adhesive can maintain cohesiveness (or keep the two layers of non-woven webs bonded) upon the relaxing of the stretched filaments during manufacture. In one embodiment, the adhesive is at least 1, 2, 4, 5, or even 6 gsm (grams per square meter) in the shirred article. In one embodiment, the adhesive is at most 8, 10, 15, 20, 40, 60, 80 or even 100 gsm in the wrinkled article. In another embodiment, the first and second non-woven webs are welded directly together such that the first non-woven porous fibrous web is in intimate contact with the second non-woven porous fibrous web. Such welding techniques are known in the art and include thermal bonding or ultrasonic welding.

After bonding (or adhering) the first and second non-woven porous fibrous webs together, the tension is released on the stretched elastic filaments and the resulting article puckers or becomes shirred. Typically, after the tension is released on the stretched elastic filaments, it could take upwards of hours or days for the wrinkled article to achieve its final puckered state as an equilibrium in the construction is reached. In one embodiment, the heat can be used to more quickly achieve this stable state.

In addition to the first and second non-woven webs, additional layers (e.g., a third layer) maybe added to the shirred article to provide additional functionality. The third layer may be added before release of the tension on the filaments, such that the third layer is also puckered or shirred. In another embodiment, the third layer is added after release of the tension on the filaments, such that the third layer is a flat layer bonded to the puckered or shirred article. Exemplary third layers include cover webs, which is a layer used to protect the underlying article from abrasion, soiling, etc. The third layer may also provide cosmetic and visual identification functionality.

In another embodiment, in addition to the first series of elastic filaments, a second series of filaments can also be used, wherein the first and second series of elastic filaments are positioned non-parallel to each other (for example at least 45 degrees or at least 90 degrees apart).

In yet another embodiment, the series of elastic filaments may be stretch to different percentages, such that when the tension is released the resulting puckered material comprises areas with more puckering and areas with less puckering.

The articles of the present disclosure are resiliently extensible under tension, meaning that when the puckered article is pulled in the same direction as the length of the elastic filaments, the puckered article can elongate (or flatten out) and when the tension is released, the elongated article returns to its puckered form. In one embodiment, the puckered article is elastically extensible to at least 2 or even 3 times of its relaxed length. In some embodiments, the puckered article comprises at least one portion which is resiliently extensible under a first tension, wherein a second portion of the wrinkled filter media is under a second tension.

Because the articles of the present disclosure have a puckered (or shirred) appearance, the basis weight of the resulting article has a higher basis weight than the original flat or unwrinkled non-woven porous fibrous webs. In one embodiment, the shirred articles of the present disclosure have a basis weight of at least 10, 15, 20, 30, 40, 50, 75, or even 100 grams per square meter (gsm). In one embodiment, the shirred articles of the present disclosure have a basis weight of at most 100, 125, 150, 175, 180, 200, 225, 250, 300, 325, 350, 375, 400, 425 or even as high as 450 gsm.

The articles of the present disclosure are self-supporting meaning that an addition layer is not needed to provide support to the non-woven web/filament/non-woven web construction, optionally comprising an adhesive.

The wrinkled or shirred articles of the present disclosure can have utility in filtering fluids, such as air or vaporous fluids. Such articles can be used to filter out undesirable particles from the fluids, such as dust, molds, oily mist aerosol, cigarette smoke, pet dander, viruses, bacteria, etc.

The filter media of the present disclosure described herein may have a variety of suitable air permeabilities. In one embodiment, the filter media has an air permeability of greater than or equal to 2, 5, 10, 15, 20, 25, 30, 40, 50, 75, 100, 120, 150, 170, 200, 275, 300, 350, or even 450 CFM/sqft. In some embodiments, the filter media has an air permeability of less than or equal to 450, 400, 350, 325, 300, 275, 250, 225, 200, 170, 150, 120, 100, 75, 60, 50, 40, 35, 30, or even 25 CFM/sqft. Combinations of the above-referenced ranges are also possible (e.g., greater than or equal to 20 CFM and less than or equal to 350 CFM/sqft, greater than or equal to 35 CFM/sqft and less than or equal to 170 CFM/sqft, or greater than or equal to 20 CFM/sqft and less than or equal to 350 CFM/sqft). Other ranges are also possible. The air permeability of a filter media may be determined in accordance with ASTM Test Standard D737 (1996). In some embodiments herein the air permeability is less than 1000 CFM/sqft.

In embodiments herein, the articles of the present disclosure can be used as a respirator. In a respirator application, the shirred, or wrinkled, article can be formed into the shape of a face mask to be worn by an individual.

In another embodiment, the articles of the present disclosure can be used as a filter for a furnace, air conditioning unit, or room air purifying unit.

Media S1 through S6 as shown in Table 4 are shirred or wrinkled media webs using flat media webs listed in Table 3. They were prepared per procedures disclosed in US Filed Dec. 21, 2022 provisional 63/434,365.

TABLE 4
Shirred nonwoven webs' initial pressure
drop and penetration in NaCl and DOP tests

| | Samples of Shirred Nonwoven Media webs | | | |
|---|---|---|---|---|
| | | | | Target |
| Media | | Top | Bottom | Stretch |
| ID. | Media | Layer | Layer | Ratio |
| S1 | Wrinkled meltblown | F2 | F2 | 50% |
| | 7.5 μm × 2, 50% | | | |
| S2 | Wrinkled meltblown | F3 | F1 | 100% |
| | 12.5 + 5 μm, 100% | | | |
| S3 | Wrinkled meltblown | F3 | F2 | 100% |
| | 12.5 + 7.5 μm, 100% | | | |
| S4 | Wrinkled meltblown | F2 | F1 | 100% |
| | 7.5 + 5 μm, 100% | | | |
| S5 | Wrinkled GDU 150 + | F5 | F2 | 100% |
| | 7.5 μm meltblown, 100% | | | |
| S6 | Wrinkled UHL × 2, 100% | F10 | F10 | 100% |
| S7 | Wrinkled UHL + 7.5 | F10 | F2 | 100% |
| | μm meltblown, 100% | | | |
| S8 | Wrinkled UHL + | F10 | F11 | 100% |
| | scrim, 100% | | | |

### Methods of Making Composite Depth Media

Method 1 (Making Type 1 media)

This section describes the method of making Type 1 composite depth media samples for testing.

Each of the composite depth media samples was adhered to the plastic frame of either a 3M™ Adflo™ filter with an opening of 144 cm², or the frame of a 3M™ Air-Mate™ filter with an opening of 102 cm². The individual layers making up the composite depth media configuration were cut to the correct dimensions for the chosen filter frame. Care was taken to properly identify each layer to ensure assembly into the filter in the correct order and orientation. The media layers were assembled into the chosen frame such that when the filter frame was assembled to the silica dust test fixture the media layers would be in the correct orientation from inlet to outlet. The edge of media layers were adhered to the filter frame using hotmelt adhesive. For samples generated with 3M™ Air-Mate™ filter frames, hotmelt adhesive was first dispensed onto the flat ledge inside the frame. The adhesive was dispensed coincident with the frame edges forming the outlet open area. The outlet media layer was then placed onto the hotmelt to seal it to the filter frame. Hotmelt adhesive was then dispensed in the same pattern on the inlet face of the outlet media layer and the next media layer was placed onto the hotmelt, sealing that layer to the layer below it. This step was repeated until the target composite depth media configuration was assembled with all layers sealed to each other and the outlet layer sealed to the filter frame to prevent penetration leaks.

Due to the orientation of the filter into the test fixture, samples generated with 3M™ Adflo™ filter frames were assembled with the media layers in the reverse order inlet to outlet compared to the Air-Mate™ samples.

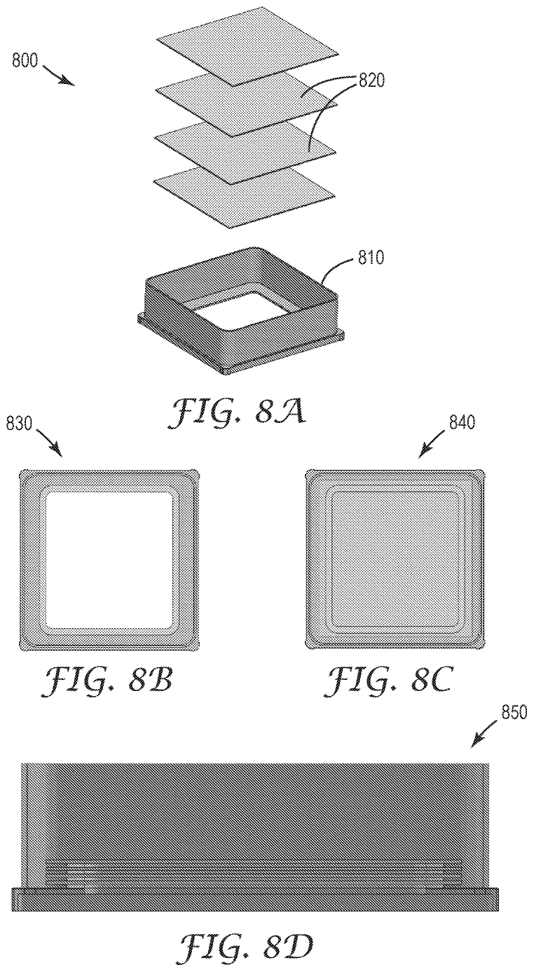

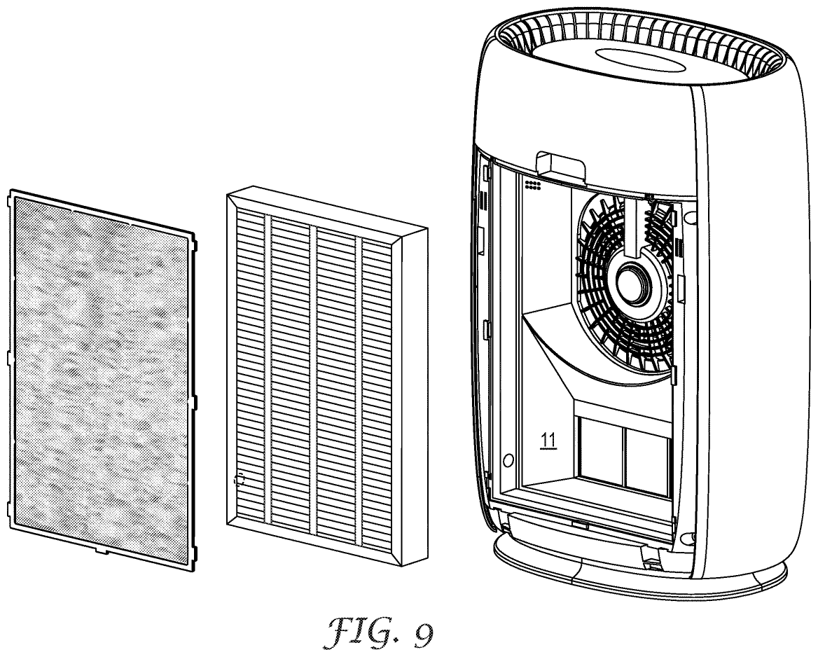

FIGS. 8A-8D illustrate the assembled composite media samples. FIG. 8A illustrates a schematic view 800 of a housing 810 into which a plurality of filter media layers 820 are housed. FIG. 8B illustrates a downstream view 830 of the assembled filter cartridge, and FIG. 8C illustrates a top view 840 (e.g. such that air flows through the surface of FIG. 8C and exits through the surface of FIG. 8B. of the assembled filter cartridge for testing. FIG. 8D illustrates a side view 850 of the assembled cartridge.)

### Method 2 (Making Type 2 Media)

This section describes the method of making Type 2 composite depth media samples for testing.

Each of the composite depth media samples was adhered to the plastic frame of the frame of a 3M™ Air-Mate™ filter with an opening of 102 cm². The individual layers making up the composite depth media configuration were cut to the correct dimensions for the chosen filter frame. Care was taken to properly identify each layer and each side of the shirred layer to ensure assembly into the filter in the correct order and orientation. The edge of media layers were assembled into the chosen frame such that when the filter frame was assembled to the silica dust test fixture the media layers would be in the correct orientation from inlet to outlet. The media layers were adhered to the filter frame using hotmelt adhesive. For samples generated with 3M™ Air-Mate™ filter frames, hotmelt adhesive was first dispensed onto the flat ledge inside the frame. The adhesive was dispensed coincident with the frame edges forming the outlet open area. The outlet media layer was then placed onto the hotmelt to seal it to the filter frame. Hotmelt adhesive was then dispensed in the same pattern on the inlet face of the outlet media layer and the next media layer was placed onto the hotmelt, sealing that layer to the layer below it. This step was repeated until the target composite depth media configuration was assembled with all layers sealed to each other and the outlet layer sealed to the filter frame to prevent penetration leaks.

The shirred media layer was assembled in their relaxed state.

### Method 3 (Making Type 3 Media)

This section describes the method of making Type 2 composite depth media samples for testing.

Each of the composite depth media samples was adhered to the plastic frame of the frame of a 3M™ Air-Mate™ filter with an opening of 102 cm². The individual layers making up the composite depth media configuration were cut to the correct dimensions for the chosen filter frame.

Care was taken to properly identify each layer and each side of the shirred layer(s) to ensure assembly into the filter in the correct order and orientation. The media layers were assembled into the chosen frame such that when the filter frame was assembled to the silica dust test fixture the media layers would be in the correct orientation from inlet to outlet. The media layers were adhered to the filter frame using hotmelt adhesive. For samples generated with 3M™ Air-Mate™ filter frames, hotmelt adhesive was first dispensed onto the flat ledge inside the frame. The adhesive was dispensed coincident with the frame edges forming the outlet open area. The outlet media layer was then placed onto the hotmelt to seal it to the filter frame. Hotmelt adhesive was then dispensed in the same pattern on the inlet face of the outlet media layer and the next media layer was placed onto the hotmelt, sealing that layer to the layer below it. This step was repeated until the target composite depth media configuration was assembled with all layers sealed to each other and the outlet layer sealed to the filter frame to prevent penetration leaks.

All shirred media layer(s) was assembled in their relaxed state.

### Method 4 (Making Respirators)

This section describes the method of making respirators using composite depth media samples for testing.

A cup-shaped disposable respirator was fabricated by first placing the designated media over a pre-molded cup-shaped shell with the wrinkles generally in the direction perpendicular to direction from nose to chin on the shell. The cup-shaped shell generally has a volume of about 230 milliliter and was made from the same shell material as the respirator available under the trade designation “3M Particulate Respirator 8210” available from 3M Co., Maplewood, MN, USA. To conform to the curvature of cup shape, the wrinkled media at the two sides next to staple or welding areas for respirator headbands were arranged to form folds. Then the wrinkled media and shell were welded together around the cup periphery to form the cup-shaped respirator.

The shirred or wrinkled media can be welded to the shell with wrinkles oriented in any other direction.

### Test Methods

To assess filtration performance, a variety of filtration testing protocols have been developed for different filters and applications.

For devices approved to EN standards, there are specific clogging tests specified. For air purifying respirators, the standard EN 143 applies and for powered air-purifying respirators the standards EN 12941 and EN 12942 apply. EN RPD standards use Dolomite as the test dust for clogging tests while NIOSH RPD standards use silica dust as the test dust for clogging tests. Dolomite is defined in EN143: 2000 clause 8.8 as DRB 4/15 dolomite with a particle diameter mass distribution of 95%<22 μm and 99.5%>1.8 μm. The allowed concentration for the test is 300-500 mg/m3. For APR the dosage is expressed in terms of the mass dosage, 263 mg*h/m3 or when the resistance of the filter is greater than threshold value. For PAPR the dosage is based on the headtop type, filter type, and filter class and ranges from 100 to 400 mg*h/m3. Many filter types are Tx3P or Tx3 (Gas) P which requires a total clogging dosage of 100-200 mg*h/m3. The NIOSH RPD standard of clogging test for PAPRs requires a dosage of 220 mg*h/m3. There is no NIOSH RPD standard of clogging for APR. For many filter types the silica dust clogging dosage is greater than the dolomite clogging dosage. In addition, the silica dust used has a smaller geometric mean particle diameter than dolomite. In simple terms the silica dust test is a longer duration test with a finer dust. The dolomite test is a shorter duration test with a coarser dust. At PAPR flowrates, the silica dust test typically leads to ~2-4×increases in filter airflow resistance compared to dolomite.

Filters herein may be configured to filter out particulates of a variety of composition and particle size distribution. RPD standards are generally concerned with respirable size ranges on the order of 0.1 to 1.0 μm. As an example generated dusts, like those from wildfires are composed of both fine respirable and coarse irritant dusts. It is not unusual for there to be equal mass proportions of PM1.0, PM2.5, and PM10 sized dusts (1.0 μm, 2.5 μm, 10 μm). While for the purposes of RPD evaluation we are generally concerned with <1.0 μm particles, it is reasonable that we could tailor depth media solutions to resist clogging for particles up to 10 μm. Note that particles >10 μm are either not present away from the source or for those working close to the source a sacrificial pre-filter is used to capture these coarse particles.

The following test methods were used to evaluate media and respirator examples. A minimum of two samples were tested and averaged for each Example (EX) and Comparative Example (CE) unless otherwise specified.

Unless otherwise noted, all initial and loading NaCl penetration and pressure drop tests for webs were run at a face velocity of 13.9 cm/sec. The listed media web performance in Tables 3 are actual measurements per Test Methods listed.

### NaCl and DOP Initial Tests and Quality Factor:

Pressure drop and percent penetration of media webs may be determined using a challenge containing NaCl or DOP (Dioctyle Phthalate) particles, delivered at a flow rate of 85 liters/min or LPM, and evaluated using a TSI™ Model 8130 high-speed automated filter tester (available from TSI Inc., Shoreview, Minnesota). An MKS pressure transducer (available from MKS Instruments, Andover, Massachusetts) may be employed to measure pressure drop (dP, mm H₂O) through the filter media or filter samples.

For NaCl instantaneous testing at 85 liters/min (i.e. LPM) and using 0.075 μm diameter particles, the particles may be generated from a 2% NaCl solution to provide an aerosol containing particles at an airborne concentration of about 16-23 mg/m3, and the Automated Filter Tester may be operated with both the heater and particle neutralizer on. The NaCl initial penetration and pressure drop tests last about 19 seconds.

For DOP testing, the aerosol may contain particles with a nominal diameter of about 0.185 μm at a target concentration of about 100 mg/m3, and the Automated Filter Tester may be operated with both the heater and particle neutralizer off. The initial DOP penetration and pressure drop tests last about 21 seconds.

The NaCl or DOP particles are forced through a media sample that has 11.4 cm in diameter or 102 cm² opening at a rate of 85 LPM.

The DOP or NaCl percent penetration is defined by Equation 2:

% Pen=(Concentration downstream/Concentration upstream)×100 Equation 2

The DOP or NaCl percent penetration and pressure drop are used to calculate a quality factor “QF” by Equation 3:

$$QF [ 1 / {mmH}_{2} O ] = \frac{- ln ( \% Pen / 100 )}{Pressure Drop ( {mmH}_{2} O )} \qquad Equation 3$$

A higher initial QF value indicates better initial filtration performance. Decreased QF values effectively correlate with decreased filtration performance.

### Silica Loading Test:

The silica particles used in loading tests followed conditions described in NIOSH Silica Dust test—42 CFR Part 84.179. The test flow rates varied for various composite depth media samples. The silica size distribution and challenge concentration, test flow face velocity through composite depth media, and test duration are summarized below.
Silica particles with a geometric mean of 0.4-0.6 microns with 99%+ less than 270 mesh (i.e. 53 microns) and standard deviation less than 2.
Silica averaged concentration in challenge air: 50-60 mg/m3.
Total test duration: 240 minutes, unless otherwise specified
Test flow face velocity: 8.6 cm/s, 7 cm/s, and 14 cm/s

The silica concentration in test chamber was measured gravimetrically before the test and during the test at an approximately one-hour interval till the end of test. The measured concentrations were averaged out to ensure it meets the requirement. A Casella CEL-712 aerosol monitor (available from Cole-Parmer, Vernon Hills, IL 60061, USA) was used to monitor silica concentration more frequently during the loading process. The volumetric flowrate was measured using the TSI 4040 mass flow meter (available from TSI Inc., Shoreview, Minnesota) and normalized to standard conditions of 101.3 Pa and 21.1° C. A manometer such as ExTech HD755 (by Grainger, 1-800-Grainger) at downstream of media sample was used in measuring pressure drop during loading. A customized computer program automatically acquired flow rate and pressure drop data at a pre-set time interval from few seconds to tens of seconds.

The silica percent penetration is defined by Equation 4:

$$\% Pen = ( Weight downstream / Weight upstream ) \times 100 \qquad Equation 4$$

### NaCl Loading Test:

Loading tests were performed on a TSI™ Model 8130 high-speed automated filter tester (available from TSI Inc., Shoreview, Minnesota) according to the procedure set forth in the tester manual. The samples received continuous NaCl challenge at 85 LPM with the particle ionizer operating. Tested flat samples had an exposed area of 100.2 cm² with a nominal face velocity of 13.9 cm/sec for flat and wrinkled media sheets.

The samples may be loaded with NaCl particles till the pressure drop reached to at least two times of initial pressure drop and calibrated photometers may be employed at the filter inlet and outlet to measure the particle concentration and the % particle penetration through the filter.

Initial NaCl efficiencies for filter media in accordance with embedment's herein may be at least 40% in some embodiments. In some embodiments, an initial NaCl efficiency is at least 50%. In some embodiments, an initial NaCl efficiency is at least 60%. In some embodiments, an initial NaCl efficiency is at least 70%. In some embodiments, an initial NaCl efficiency is at least 75%. In some embodiments, an initial NaCl efficiency is at least 80%. In some embodiments, an initial NaCl efficiency is at least 90%. In some embodiments, an initial NaCl efficiency is at least 95%. In some embodiments, an initial NaCl efficiency is at least 98%. In some embodiments, an initial NaCl efficiency is at least 99%.

### Welding Fume Loading Test:

Welding fume is formed in welding process, where metal is heated and melted using an electrical arc, gas torch, etc. and some of the heated metal vaporizes and quickly condenses to form very small particles in the air. These small particles may also join together to form longer aggregate chains. In this test, the welding fumes were generated by flux-cored arc welding (FCAW) with mild steel wire on mild steel base metal.

FCAW was carried out with CO₂ gas. Mild steel base metal (SS400, Fe_98%, C_0.30%, and Mn_1.60%) was placed on the base turntable and 1.2 mm of flux-cored wire (SF-71, AWS E71T-1, Hyundai Welding Co., Korea) was fed at a speed of 13 cm/s into the torch. The welding machine (IB-350, Chowel Co., Korea) was set to generate the current of 232 A and voltage of 22 V on average. The welder was operated in a cycle of 3-seconds on followed by 60-second off, yielding an average fume concentration of 86.0 mg/m3 [standard deviation (SD) 25.4 mg/m3]. Welding variables such as the welding time, wire feeding rate, welding speed, torch angle, and distance between contact tube and work piece were controllable.

The welding fumes were not neutralized. The welding fume particles have a CMD (Count Median Diameter) of 210-221 nm. Test room conditions were set at 23° C. (21-24° C.) and 20% (17-22%) RH.

The fume generation system used has the welding chamber connected to the test chamber where the welding fume is drawn into. The composite media samples were mounted in a test chamber with a 10 cm diameter opening. To measure filter penetration and pressure drop, a filter efficiency tester (SIBATA, AP-634A, Japan) and a manometer (OKANO, DMP-202N, Japan) were used simultaneously. A constant flow rate of 66 LPM was applied to composite depth media samples, which is corresponding to 14 cm/s face velocity. For respirator samples, a constant flow rate of 85 LPM was applied. At least two duplicates of each media or respirator sample were tested. Flow was controlled with a Dwyer Series RMC-104-CPF Rate-Master Flowmeter connected to a GAST rotary vane pump (Model 0523-101Q-SG588DX). A computer program was developed using Lab VIEW to acquire analog signals from the upstream and downstream photometer and the manometer.

The loading test was stopped once the accumulated loading of welding fume particles reached approximately 200 mg. The silica percent penetration is defined by Equation 5:

$$\% Pen = ( Weight downstream / Weight upstream ) \times 100 \qquad Equation 5$$

### Loading Quality Factor:

The loading quality factor (LQF) at a given face velocity for silica, welding fume, and NaCl particles was calculated to compare composite depth media samples for their ability of capturing particles per unit of surface area and per pressure drop increase. It is defined by Equation 6:

$$LQF = \frac{Total loaded particle mass ( 1 - \% Pen / 100 )}{Area * Pressure Drop Delta} \qquad Equation 6$$

The Area is the actual surface area for flat media layers or pleated or corrugated media structure. The Area is projected surface area for shirred or wrinkled media layers as they are substantially flat sheets. The Pressure Drop Delta is the pressure drop increase at the end of loading determined by either the total loading time or the total loading weight. LQF has the unit of [mg/cm²/mmH₂O]. At a given flow face velocity, a higher LQF indicates higher capture of aerosol particles by the media sample at the same pressure drop increase per unit area.

Details for measuring these values are presented in the Examples section.

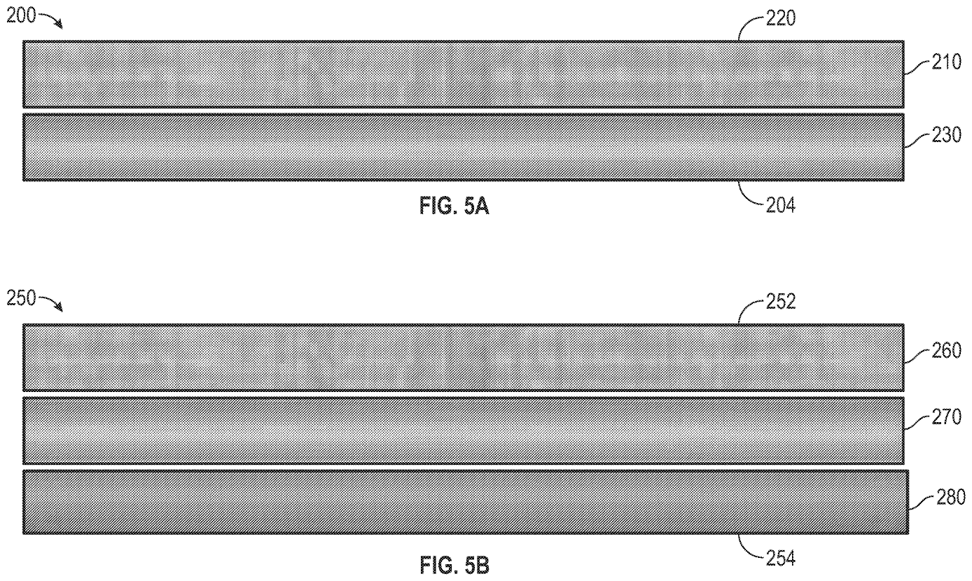

FIGS. 5A-5B illustrates a schematic representation of a cutaway view of a filter media in accordance with embodiments herein. FIG. 5A illustrates a cutaway view of a filter media 200, with an inlet or upstream surface 202 and an outlet or downstream surface 204. Air flows through filter media through inlet surface 202, through filter layer 210, then through filter layer 230, before exiting outlet surface 204. In some embodiments, layer 210 is a high-loading-capacity layer while layer 230 is a high efficiency layer.

Layers 210, 230 are illustrated as distinct portions of a filter media 200. In some embodiments, each layer 210, 230 is manufactured separately and then filter media 200 is assembled. In some embodiments, a dividing material, such as scrim, netting or another suitable material, is present between layer 210, 230. However, in some embodiments, materials for both layers 210, 230 are assembled and then filter media 200 is constructed, such that layer 210 and layer 230 are formed simultaneously. In some embodiments, filter media 200 is die cut.

Filter media 200 is depicted as having flat surfaces 202, 204. However, it is expressly contemplated that layers 210, 230 may be composed of nonwoven materials that may interleave with each other. As used herein, “surface 202” and “surface 204” is intended to refer to a contacting surface placed in front of (or behind) filter layer 210, 230, in contact with a majority of a nonwoven web.

In some embodiments, filter layer 230 is composed of at least one sheet of wrinkled media. The increased surface area of a wrinkled media sheet may help ensure that filter layer 230 has a high enough efficiency for intended applications.

In some embodiments, filter layer 210 is composed of at least one sheet of wrinkled media. The increased surface area of a wrinkled media sheet may increase the particulate loading capacity of filter layer 210. This may allow for a higher loading capacity with fewer sheets of media. Alternatively, this may allow for a filter media 200 with a wrinkled media layer 210 to have the same capacity as a filter media 200 without a wrinkled media layer, but have a lower pressure drop.

In some embodiments, filter layers 210, 230 are both composed of wrinkled media. Filter layer 210 may be formed from one or more sheets of wrinkled media that is configured for high-loading-capacity of particulates. Filter layer 230 may be formed from one or more sheets of wrinkled media that is configured for high filtration efficiency.

FIG. 5B illustrates a schematic cutaway view of another embodiment of a filter media 250. Filter media 250 has three layers, an inlet or upstream layer 260, which has an inlet surface 252, an outlet or downstream layer 280, having an outlet surface 254 and a middle layer 270. Air flows through the filter such that surface 252 is contacted by air first, then layer 260, then layer 270, then layer 280, before exiting surface 254.

Middle layer 270 contacts outlet layer 280, on one side, and inlet layer 260, on a second side. Layers 260, 270, 280 may be formed independently and then combined to form filter 250, in some embodiments. In other embodiments two or more of layers 260-280 may be formed simultaneously, e.g. the one or more sheets of nonwoven media of layers 260-280 are stacked together and then sealed together.

In some embodiments, one or more of layers 260-280 may be composed of wrinkled media. An inlet layer 260 formed of wrinkled media may have higher particulate loading capacity than a similarly constructed inlet layer formed of flat non-woven material. Or inlet layer 260 may have the same loading capacity as a comparable inlet layer formed of flat non-woven material, but experience a lower pressure drop. An outlet layer 280 formed of wrinkled media may provide similar efficiency as a comparable outlet layer 280 with a lower pressure drop, but a higher filtration efficiency due to the increased surface area.

A middle layer 270 may be composed of material designed for high-loading-capacity loading, high efficiency loading, or a mixture of both. In some embodiments, a middle layer 270 may function as a second high-loading-capacity filter layer, or as a first high efficiency layer. Generally, layers 260, 270 and 280 are designed to capture particulates of different size ranges.

FIGS. 5A and 5B illustrate filters 200, 250 with layers having equal thickness. It is expressly contemplated, however, that in some embodiments, layers 210, 230 or 260-280 have different thicknesses.

Each wrinkled media layer may have a low height or thickness profile. In some embodiments, a wrinkled media layer has an average thickness less than about 25 mm. In some embodiments, a wrinkled media layer has an average thickness less than about 20 mm. In some embodiments, a wrinkled media layer has an average thickness less than about 15 mm. In some embodiments, a wrinkled media layer has an average thickness of less than about 10 mm. In some embodiments, a wrinkled media layer has an average thickness of less than about 6 mm. In some embodiments, a wrinkled media layer has an average thickness of less than about 3 mm. In some embodiments, a wrinkled media layer has an average thickness of less than about 2 mm. In some embodiments, a wrinkled media layer has an average thickness of about 1 mm.

Generally, high-loading-capacity layers of a filter media capture particulates by depth filtration mechanism. High-loading-capacity layers can be formed of sheets of nonwoven media formed from fibrillated film, from sheets of spunbond or lofty spunbond, from staple fibers, or from nonwoven sheets having another suitable fibers, depending on the particulates to be removed. A high-loading-capacity layer of a filter media is expected to capture the majority of particulates from the air with low pressure drop.

Respiratory filters are generally designed to filter out a variety of particles. A high-loading-capacity layer is designed to remove a majority of the particles but may be less efficient at capturing smaller sizes. In some embodiments herein, high-loading-capacity layers are less effective for sub-micron sized particulates.

In some embodiments, a high-loading-capacity filter layer includes at least some fibers that are electrically charged. In some embodiments, a high-loading-capacity filter layer includes one or more sheets of nonwoven media having electrically charged fibers.

In some embodiments, a high-loading-capacity filter layer is composed of one or more layers of wrinkled media, which provides significantly higher surface area per square inch of filter.

High-loading-capacity layers of filter media generally are designed to capture particulates within the depth of high-loading-capacity layer, and not to aggregate on a surface of the layer, which may cause a pressure drop to increase and require earlier replacement. In some embodiments, a high-loading-capacity layer of a filter media is composed of a lofty nonwoven fabric, e.g. having a solidarity below 12%, which allows for particulates to travel into the layer before embedding therein.

High efficiency layers of a filter media generally capture particulates with one or more sheets of nonwoven media with smaller fibers. High efficiency layers may be formed from sheets of nonwoven material composed of meltblown fibers, or micro glass fibers, or nanofibers, another suitable fiber. High efficiency layers may include a membrane, in some embodiments herein.

In some embodiments, a high efficiency filter layer includes at least some fibers that are electrically charged. In some embodiments, a high efficiency filter layer includes one or more sheets of nonwoven media having electrically charged fibers.

In some embodiments herein, a high-loading-capacity layer captures a majority of particulates in air being filtered. In some embodiments, an efficiency layer has a lower capacity than a high-loading-capacity layer of a filter media.

In some embodiments herein, a transition layer is present between a high-loading-capacity layer and an efficiency layer. The transition layer may be composed a nonwoven media with a higher efficiency than the high-loading-capacity layer. In some embodiments, the transition layer has a lower efficiency than the high-efficiency layer. In some embodiments, the transition layer has a higher capacity than the high-efficiency layer. A transition layer may be composed of one or more sheets of lofty nonwoven fabric. The transition layer may be composed of one or more layers of wrinkled media, providing a higher surface area and, therefore, higher capacity, than a flat layer of nonwoven media.

While depth loading and surface loading are described above in a general manner, it is expressly contemplated that filter media often has aspects of both filtration techniques. For example, high efficiency layers may have multiple sheets of material because some particulates do pass through a first layer and get captured within a second layer. Additionally, it is noted that some filter media may balance capacity and efficiency. In some embodiments, a transitional layer, between a high-loading-capacity layer and a high efficiency layer, may have both high efficiency and high-loading-capacity properties for capturing a given particulate challenge.

In some embodiments, filter layers are manufactured separately and then attached, for example using stitching, adhering, heat bonding, welding, die-cutting or another suitable mechanism. In some embodiments, sheets of media forming each filter layer are assembled and formed into a filter media in one step.

Filter layers in embodiments herein composed of sheets of charged split-fiber media, spunbond media, blown micro fibers, fibrillated film, or another suitable material. Fibrillated film and methods of manufacture are described in U.S. Pat. No. RE32171, published on Jun. 3, 1986). In embodiments where fibers formed from fibrillated films are used, it is noted that fibers have a rectangular cross-section.

In some embodiments herein, fibrillated film fibers can be obtained from by 3M Company. Fibrillated film fibers described herein may have a rectangular cross section of 10 micrometers (μm)×40 μm, due to the superior electrostatic maintaining rate which provide these fibers with excellent particulate capture characteristics. However, it is expressly contemplated that other fibrillated film fiber dimensions may be used in accordance with embodiments described herein.

In demanding filtration applications, it is highly desired for filtration media to deliver high efficiency, high particulate loading and low pressure drop. Those performance are however competing attributes in nature. For example, higher efficiency media typically leads to higher pressure drop, and higher loading capacity media can lead to higher pressure drop as well.

Described herein are filter media with two or three distinct layers. However, it is expressly contemplated that additional layers are possible. For example, a filter media could have four layers, or five layers, or six layers. The layers transition, going from an inlet surface to an outlet surface, may transition from having more high-loading-capacity attributes to having more high-efficiency attributes. Filter media according to embodiments herein may also have more than six layers. In some embodiments, each layer differs in one or more parameters from an adjacent layer. Parameters distinguishing one layer from an adjacent layer may include one or more of: fiber material, fiber size, fiber density, loftiness, type of non-woven or membrane, numbers of sheets of media in the layer, or another parameter that affects capacity or efficiency.

Filters herein may have one or more layers of wrinkled media. Wrinkled media layers may differ from one another by additional parameters specific to the wrinkling process, such as elastic filament material, diameter, degree of density in a relaxed state, stretch ratio, adhesive, or another suitable parameter.

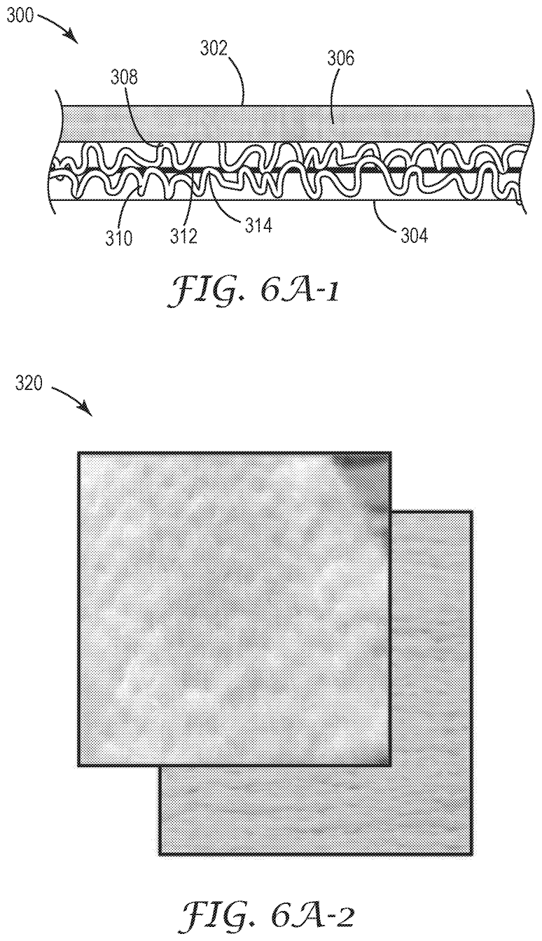

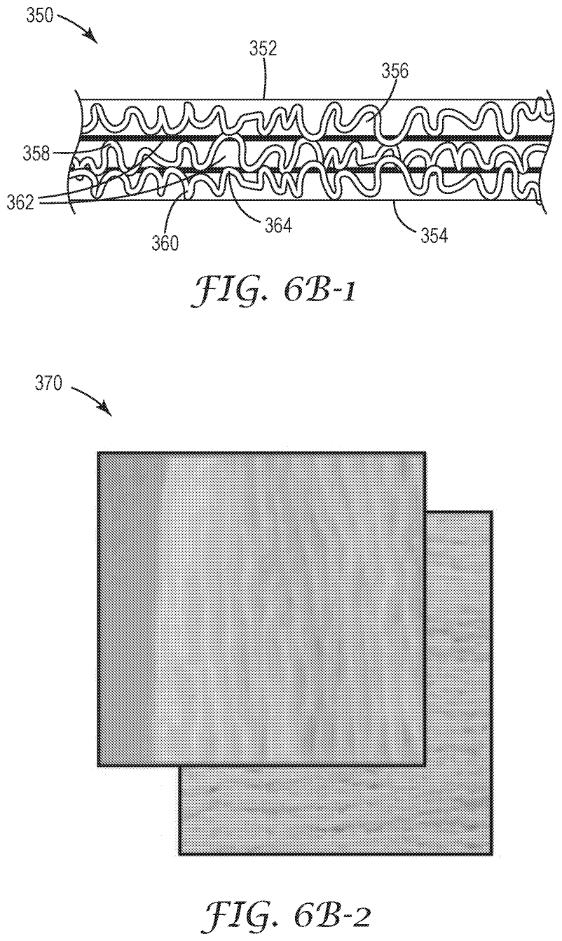

FIGS. 6A-6B illustrate schematic cross-sectional views of filter media made in accordance with embodiments herein. Filter media 300 is illustrated as having three layers between an inlet or upstream surface 306 and an outlet or downstream surface 304. Air passing through filter media 300 first encounters surface 302, then through layer 306, then through layer 308, then through layer 310 before exiting the projected outlet surface 304.

Filter 300 illustrates an embodiment where layers 310 and 308 are formed from wrinkled media. While FIG. 6A-1 illustrates a schematic in which a single sheet of wrinkled media forms each of layers 308, 310. However, it is expressly contemplated that a filter layer, such as layer 308 or 310, may be formed from multiple sheets of wrinkled media. FIG. 6A-1 also illustrates a separating layer 312 between layers 308 and 310. Separating layer 312, in some embodiments, is a scrim, a netting or another suitable separator. It is expressly contemplated, however, that not all embodiments herein include a separating layer.

While filter 300 is illustrated as having a separator between layers 308 and 310, it is expressly contemplated that, in some embodiments, no separating layer 312 is present. In such embodiments, the line representing separation mechanism 312 in FIG. 6A-2 can be illustrative of how adjacent layers of wrinkled media may interact. Because of how a sheet of wrinkled media folds during the wrinkling process. In some embodiments, a first layer of wrinkled media may at least partially overlap with a second layer of wrinkled media, along a thickness 314 of filter 300.

As illustrated in FIG. 6A-1, two different types of wrinkled media are used, one for layer 308 and one for layer 310. The composition of layers 308, 310 may differ with respect to type of fiber, thickness of fiber, density of fibers, type of elastic filament, space between adjacent elastic filaments, amount of stretch of the elastic filaments during the wrinkling process, or other adjustable parameters.

FIG. 6A-2 illustrates an example filter 320 formed by layers as illustrated in FIG. 6A-1, e.g. an outer layer of flat nonwoven media, and both a transition and inner layer formed of wrinkled media.

FIGS. 6B-1 and 6B-2 illustrate a filter with three wrinkled media layers, in accordance with embodiments here. Filter schematic 350 represents a composition of filter 370. Filter 350 includes three layers—an outer layer 356, a transition layer 358 and an inner layer 360. An outer surface is illustrated by line 352.

It is expressly contemplated that, for layers of wrinkled material, a surface is not necessarily a flat surface. For wrinkled media, a surface 352 can be defined as a theoretical surface. Lines 362, similarly, represent a theoretical surface. A theoretical surface can be defined as either (1) an average height of individual wrinkles measured from an elastic filament, or (2) a surface that a majority of the surface of a wrinkled media layer would touch when in use. It is expressly contemplated that, in some embodiments, adjacent layers may overlap with one another, e.g. such that one or more wrinkles of a first layer extend into a second layer, along a thickness 364 of a filter 350. It is also contemplated that, in some embodiments, a physical separation 362 is present between either, or both of layers 356, 358 or 358, 360.

Layers 356-360 are illustrated in FIG. 6A-1 as having similar thicknesses, measured along a filter thickness 314. However, in some embodiments, different layers have different thicknesses. For example, a high-loading-capacity layer may be composed of more sheets of wrinkled media, or thicker sheets of wrinkled media than a high-efficiency layer.

FIG. 6B-2 illustrates an example filter 370 formed by layers as illustrated in FIG. 6B-1, e.g. an outer layer of flat nonwoven media, and both a transition and inner layer formed of wrinkled media.

Described herein are filters that may be used to make disposable respirators or for use in a filter pack. Filters herein include one or more layers composed of wrinkled media, which provides a larger surface area for particulate collection without needing to add more layers of fabric.

Wrinkled layers herein are composed of wrinkled nonwoven media, which may be made according to the method described in FIGS. 3-4, and described in greater detail in the Examples section of U.S. Provisional Patent Application 63/434,365, Filed Dec. 21, 2022, incorporated herein by reference. Different fibers, and different elastic filaments may be used depending on the capacity and/or efficiency needed.

Fibers used in embodiments herein may have an effective fiber diameter between 4 μm and 100 μm. In some embodiments herein, fibers have an effective fiber diameter between 4 μm and 50 μm. In some embodiments herein, fibers have an effective fiber diameter between 10 μm and 40 μm.

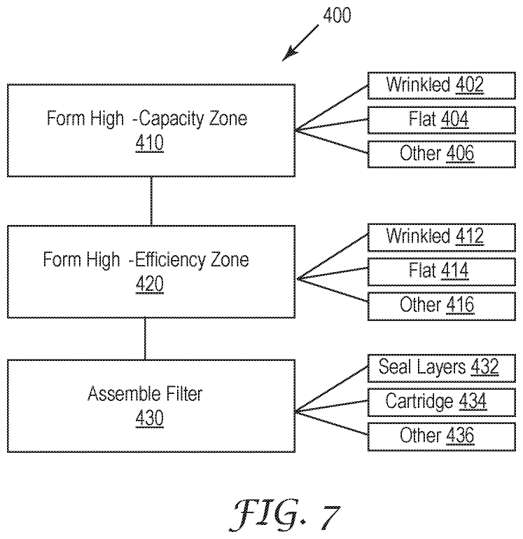

FIG. 7 illustrates a method of forming a filter in accordance with embodiments herein. Method 400 may be useful for making disposable respirators, filters for PAPRs or other breathing apparatus, or for other filtering applications. Filters formed using method 400 are composite filters, composed of at least two different materials.

In block 410, a high-loading-capacity zone of a filter is formed. The high-loading-capacity zone may be formed of one or more layers, each including one or more sheets of nonwoven fabric. The nonwoven fabric is wrinkled, as indicated in 402, in some embodiments. In some embodiments the nonwoven fabric is a flat nonwoven fabric, as indicated in block 404. Other media may also be used, such as glass fiber media, a membrane or another filtering or adsorption material, such as a sorbent material, as indicated in block 406.

In block 420, a high-efficiency zone of a filter is formed. The high-efficiency zone may be formed of one or more layers, each including one or more sheets of nonwoven fabric. The high-efficiency zone, in some embodiments, is composed of wrinkled nonwoven media, as indicated in block 412. In some embodiments, the high efficiency zone is composed of one or more flat nonwoven fabric sheets, as indicated in block 414. Other suitable filtering media, such as a glass fiber media, a membrane or other filtering mechanism, may also be used, as indicated in block 416.

In block 430, a filter is assembled. Forming the filter includes arranging the high-loading-capacity and high-efficiency zone such that filtered air will first pass through the high-loading-capacity zone before passing through the high-efficiency zone. In some embodiments, the high-loading-capacity zone is formed into a high-loading-capacity layer, the high-efficiency zone is formed into a high-loading-capacity layer, and then the two layers are sealed together. In some embodiments, the nonwoven fabric sheets for each zone are assembled as an unsealed stack of sheets, which are then sealed together in one step.

Sealing, as indicated in block 432, can include die-cutting, welding, bonding, stitching, a combination of these, or another suitable sealing mechanism.

Assembling the filter may also include forming the filter media into a desired shape, e.g. a cup-shape for a cup-shaped disposable respirator, or sealing panels together for a vertical-fold or horizontal fold disposable respirator. In embodiments where the filter will be used in a PAPR, or other apparatus with a replaceable filter cartridge, assembling includes forming the filter for placement in a cartridge or other housing. Assembling a filter may include other steps as well, as indicated in block 436.

Using wrinkled media in one or more layers of a composite filter provides several advantages. As described herein, wrinkled media provides more surface area per square inch (or cm) of a filter than flat media. This provides increased comfort for a user as higher capacity can be provided without a decrease in comfort. Another advantage of using wrinkled media is in the assembly stage, e.g. block 430 of method 400. Conventional filters are often pleated before placement in a filter cartridge or housing. The pleating process can be a bottleneck in the manufacturing process. Using wrinkled media provides more surface area with fewer sheets, making mechanical means for creating surface area (pleating or other folding techniques) unnecessary.

Because wrinkled media can provide the same capacity, with fewer sheets of nonwoven media, there is less physical media that needs to fit in a cartridge or housing. This can either allow for a smaller housing, when using wrinkled media, than that required for conventional pleated filter media.

In some embodiments herein, filters composed of composite media layers as described herein demonstrate sufficiently high silica loading capacity to pass silica test requirements per NIOSH 42 CFR 84 procedures, while having final pressure drops of 20-60% lower than current pleat packs, while maintaining >99.95%+ initial DOP photometric and CPC filtration efficiency. Additionally, filters made according embodiments herein also demonstrated high salt loading capacity.

It is expressly contemplated that, depending on requirements of a given filter application, composite media may be tailored, as described herein, to have fewer layers or the same number of layers with each having different properties in basis weight or thickness or solidity.

It is also noted that, because unpleated sheets of media are better able to conform to curved surface or irregular shapes. Gas and vapor filter devices with housings that are circular or oval, or other curved shapes can benefit from filters described in embodiments herein, which is generally not feasible with pleat packs.

While much of the description herein has focused on using filter media herein for respiratory applications, it is expressly contemplated that filter media constructed herein may be beneficial for other examples. FIGS. 9-11 illustrate some other applications where filter media embodiments herein may be particularly useful.

FIG. 9 illustrates a room air purifying device in accordance with some embodiments herein. Specifically, filter media embodiments herein may be particularly useful as a prefilter layer in front of a primary, pleated filter for use in room air purifiers (RAP). Typically, a primary RAP filter has a high density of pleats (e.g., from about 3 per inch to about 8 per inch), and also typically the filter media used in RAP filters is of a HEPA grade, which has a minimum of 99.97% efficiency for 0.3 μm particle size. Such filters are often expensive, and consumers and manufacturers look for ways to extend the life of the primary pleated filter. Several types of prefilters are currently found in the market, including mesh screens, (for example, as illustrated in PCT Publication WO2017161530, published Sep. 28, 2017, FIG. 3 of which, and the associated description, are incorporated herein by reference) and carbon prefilters made of porous open-cell foam or a low-density flat layer of nonwoven (a similar structure to Scotch-Brite™ sold by 3M Company) coated with activated carbon. Media for filtration applications described herein media may be formed of a low airflow resistance media (relative to the HEPA media) to create a high dust-holding capacity prefilter which will capture a large amount of dust during use, which will help prolong the life of the primary filter. The prefilter may be replaced or cleaned at a more frequent service interval than the primary filter. The wrinkled media prefilter can help maintain a lower total filtration system airflow resistance over the life of the air purifier compared to using a pleated HEPA filter alone. Such prefilters may be used on planar, cylindrical, or other shapes of RAP filters. Various structures may be used to help attach the prefilter to the primary filter or air purifier housing, such as adhesive, clips, hooks, etc. In certain embodiments, the wrinkled media may also be formed from media suitable to serve as the primary filter in a room air purifier. FIG. 9 illustrates an exploded view of an RAP, with air flowing first through a pre-filter formed of wrinkled filter media before encountering a primary filter of the RAP.

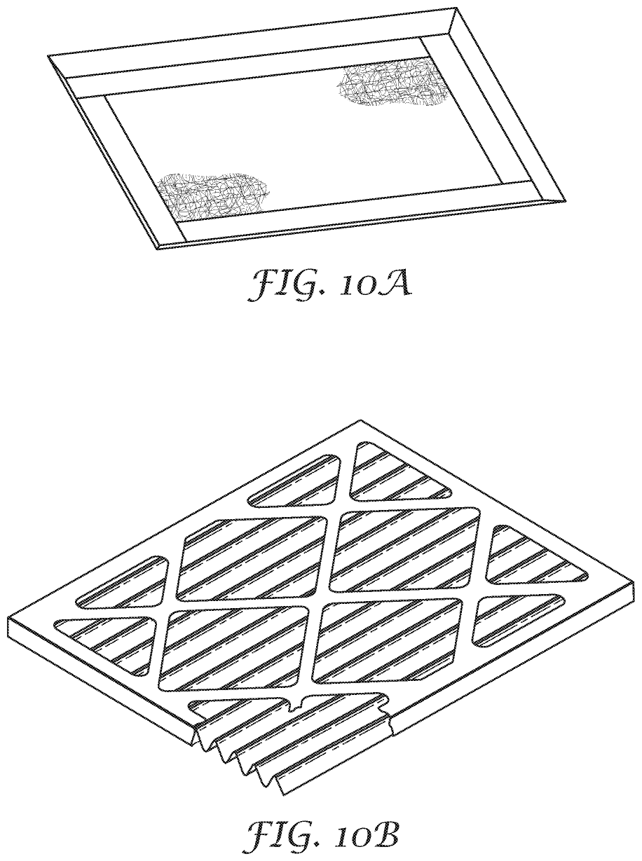

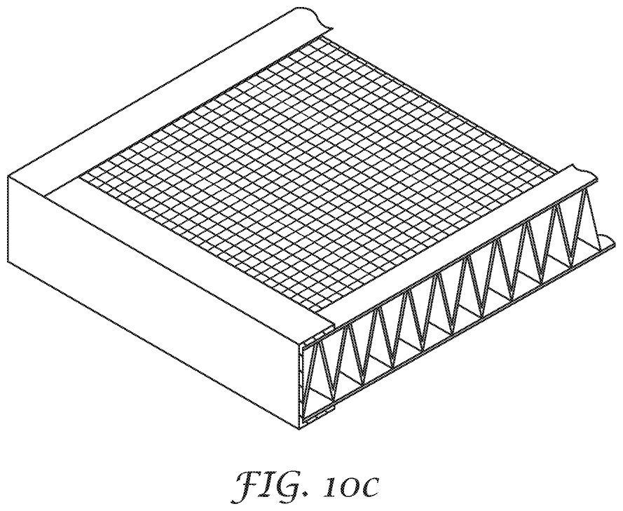

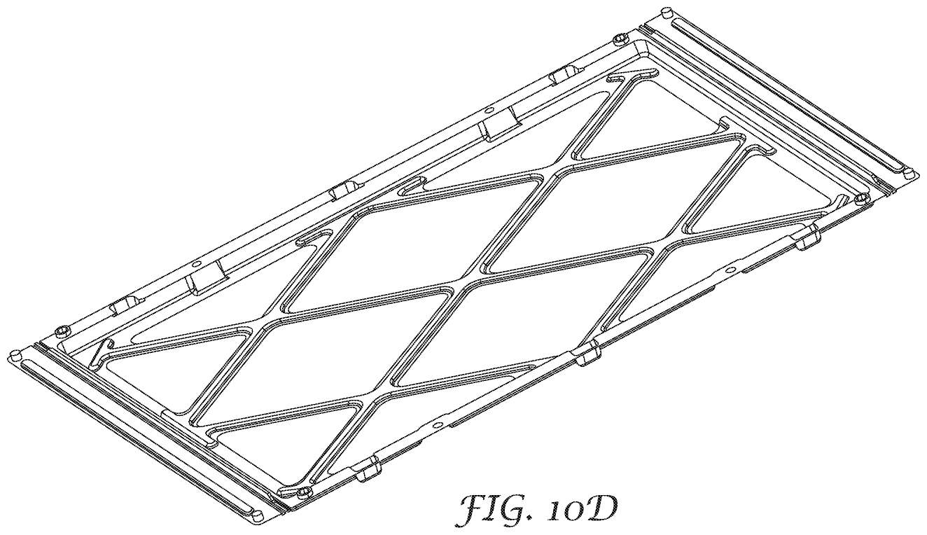

FIGS. 10A-10D illustrate different HVAC filter configurations in accordance with some embodiments herein. Wrinkled filter media may be used in flat form as the filtration layer in HVAC filters, both for residential and commercial type HVAC filters. Residential filters of nominal 1″ thickness may be particularly suited for use with wrinkled filter media embodiments described herein. Using wrinkled filter media effectively multiplies the surface area of the filter media in the filter structure, and the greater media surface area will reduce the airflow resistance of the filter structure and enhance the dust holding capacity of the filter media.

Wrinkled filter media in accordance with embodiments herein may be suitable to replace several existing types of filter media constructions commonly found in HVAC filters, for example e.g., flat-sheet media, e.g., as shown in 10A; sinusoidal-like pleats, e.g., as shown in FIG. 10B; and triangular-shaped pleats, e.g., as shown in FIG. 10C.

Wrinkled filter media of embodiments herein may be used in expandable or refillable filters, such that that illustrated in FIG. 10D, in which the inherent stretchability of the media may be utilized to ship a media or filter element in a compressed or collapsed state, reducing shipping costs and/or package size. Additionally, using wrinkled filter media in an expandable/refillable filter may also provide a filter that is adjustable in size in one or more major dimensions For example, it may be possible to stretch filter media herein from a 20×20″ filter element such that it also functions as a 20×25″ filter element.

Wrinkled media may be constructed into a filter in either a frameless or framed construction. Suitable types of filter frames for HVAC filters include box frames, (e.g., as shown in US2012/0272829, FIG. 1 and associated description of which are incorporated by reference herein), channel frames, (e.g., as shown in PCT Publication WO2015/034799, FIG. 6 and associated description of which are incorporated by reference herein); other strip frames, optionally nestable, (e.g., as shown in US2015/0265957, FIG. 1 and associated description of which are incorporated by reference herein); and in refillable frames or housings, (e.g., as shown in US2017/0182445, FIG. 9 and associated description of which are incorporated by reference herein).

HVAC filters above entry-level performance nearly universally incorporate a pleated filter media to increase the surface area of the filter media, which in turn decreases the airflow resistance of the filter and increases the available area for capturing dust and other pollutants on the filter, thus extending the filter's useful lifetime. Filter pleating is also used to incorporate higher efficiency filter media into a filter while still maintaining a certain level of airflow resistance, as higher efficiency media generally tends to be of higher airflow resistance.

Wrinkled media, which already has a three-dimensional form, may be further incorporated into an air filter by pleating the wrinkled media. In this extended surface area construction, further benefits may be achieved to the filter's airflow resistance, dust holding capacity, and/or efficiency. Suitable pleat density may range from, e.g., 0.3 to 5 pleats per inch.

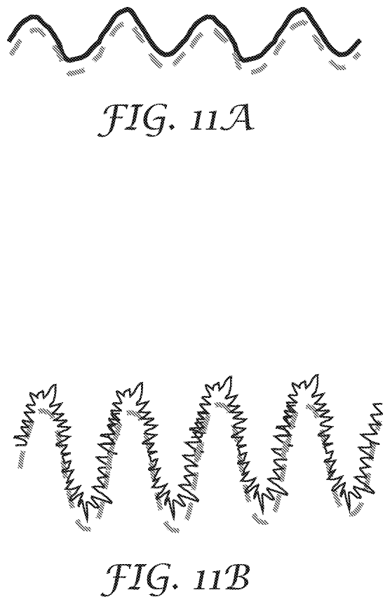

FIGS. 11A-11B illustrate a cross-sectional view of a filter in accordance with some embodiments herein. FIG. 11A illustrates an example of prior art filter media, where a filter media assembly include a highly open wire mesh or screen, one or more adhesive strands, etc., that is bonded to the wrinkled filter media in order to enhance the pleatability thereof and that is pleated along with the wrinkled filter media itself. The wire mesh or screen (or other additional component) may impede re-collapsing of the pleated version of the filter media assembly from the expanded condition.

FIG. 11B illustrates a highly open wire mesh with pleated wrinkled filter media adhered or otherwise connected thereto. Such a configuration provides two different three dimensional compaction techniques to a nonwoven article-first by wrinkling, and then by pleating the wrinkled media.

The pleated wrinkled media may be suitable for use in any of the frame configurations noted for the “flat form” HVAC filter, including frameless, rigid frame constructions, refillable constructions, and expandable constructions.

In some embodiments, filter media herein comprises a nonwoven web that can have random fiber arrangement and generally isotropic in-plane physical properties (e.g., tensile strength), or if desired may have aligned fiber construction (e.g., one in which the fibers are aligned in the machine direction as described in U.S. Pat. No. 6,858,297 to Shah et al., the teachings of which are incorporated herein by reference) and anisotropic in-plane physical properties. Some or all of the fibers comprising the nonwoven webs useful with the filter media embodiments described herein can be multicomponent fibers having at least a first region and a second region, where the first region has a melting temperature lower than the second region. Some suitable multicomponent fibers are described, for example, in U.S. Pat. Nos. 7,695,660, 6,057,256, 5,597,645, 5,972,808, 5,662,728 and 5,486,410 the teachings of each of which are incorporated herein by reference in their entireties.

Other nonwoven webs useful with filter media embodiments described herein can be a high loft spunbond web, such as described, for example, in U.S. Pat. No. 8,162,153 to Fox et al., the entire teachings of which are incorporated herein by reference. In other embodiments, the filter media 60 can be a low loft spunbond web, such as those described in U.S. Pat. No. 7,947,142 to Fox et al., the entire teachings of which are incorporated herein by reference. In yet other embodiments, nonwoven webs useful with filter media embodiments described herein are generated by other techniques and/or have other characteristics, such as the meltblown nonwoven webs disclosed in U.S. Pat. No. 6,858,297 to Shah et al., Other nonlimiting example of useful nonwoven web formats include bi-modal fiber diameter meltblown media such as that described in U.S. Pat. No. 7,858,163, the entire teaching of which are incorporated herein by reference. Additional media types which may be suitable include webs produced from staple fibers, membranes, wet-laid nonwovens, and various forms of meltblown nonwovens.

Wrinkled filter media in the embodiments herein may also be useful to provide a filtration function for many other air-moving applications like air conditioners, dehumidifiers, fans, recirculating kitchen vents (such as those commonly found on microwaves), cooling fans for electronic equipment, air supply registers, air returns, vents, and intakes. This list is not intended to be exhaustive—it is expressly contemplated that other devices providing an air filtration function may also benefit from embodiments described herein.

It is also noted that filter media in accordance with embodiments herein can satisfy particulate loading requirements with fewer sheets of filter media. For PAPRs class, this flat sheet composite media can be reduced to fulfill the load need with low pressure drop, which may lead to smaller, lighter and quieter unit. Described herein are different filter configurations that may be used to meet capacity and pressure drops are described herein that do not use wrinkled media in any layer.

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

A filter media is presented that includes a first layer comprising a first plurality of fibers. The first plurality of fibers are characterized by an average diameter of less than or equal to about 50 microns, a thickness greater than or equal to about 1.7 mm, and a basis weight of greater than or equal to about 90 gsm. The first layer has an initial NaCl efficiency of less than or equal to about 75% at 14 cm/s face velocity. The filter media also includes a second layer having a second plurality of fibers, the second plurality of fibers being characterized by an average diameter of greater than or equal to 8 microns. The second layer has an initial NaCl efficiency of greater than or equal to about 75% at 14 cm/s face velocity.

The filter media may also include a third layer, including a third plurality of fibers, the third plurality of fibers being characterized by an average diameter of less than or equal to about 8 microns, and an initial NaCl efficiency of greater than or equal to about 90% at 14 cm/s face velocity. The NaCl efficiency of the third layer is great than the initial NaCl efficiency of the second layer.

The filter media may also characterized in that at least a portion of the third plurality of fibers are in contact with a portion of the second plurality of layers.

The filter media may also be characterized in that the initial NaCl efficiency is greater than or equal to about 99% at 14 cm/s face velocity.

The filter media may also be characterized in that the initial NaCl efficiency of the filter media is greater than or equal to about 98% at 14 cm/s face velocity.

The filter media may also be characterized in that the initial NaCl efficiency of the filter media is greater than or equal to about 95% at 14 cm/s face velocity.

The filter media may also be characterized in that the initial NaCl efficiency of the filter media is greater than or equal to about 90% at 14 cm/s face velocity.

The filter media may also be characterized in that the initial pressure drop of the filter media is less than or equal to about 9 mmH2O at 8.6 cm/s face velocity.

The filter media may also be characterized in that the initial pressure drop of the filter media is less than or equal to about 10 mmH2O at 7 cm/s face velocity.

The filter media may also be characterized in that the initial pressure drop of the filter media is less than or equal to about 20 mmH2O at 14 cm/s face velocity.

The filter media may also be characterized in that the silica loading capacity per NIOSH test method of the filter media is greater than or equal to about 0.24 mg per (mmH2O·cm²) at 8.6 cm/s face velocity.

The filter media may also be characterized in that the silica loading capacity of the filter media per NIOSH test method is greater than or equal to about 0.5 mg per (mmH2O·cm²) at 7 cm/s face velocity

The filter media may also be characterized in that the silica loading capacity of the filter media per NIOSH test method is greater than or equal to about 0.3 mg per (mmH2O·cm²) at 14 cm/s face velocity

The filter media may also be characterized in that the first layer comprises wrinkled media.

The filter media may also be characterized in that the first layer comprises a membrane.

The filter media may also be characterized in that the first layer comprises a sorbent.

The filter media may also be characterized in that the first layer comprises meltblown fibers.

The filter media may also be characterized in that the layer comprises fibrillated film.

The filter media may also be characterized in that the first layer comprises spunbond fibers.

The filter media may also be characterized in that the first layer comprises fibers having an effective diameter under 40 μm.

The filter media may also be characterized in that the first layer fibers having an effective diameter under 20 μm.

The filter media may also be characterized in that the first layer comprises fibers having an effective diameter under 15 μm.

The filter media may also be characterized in that the first layer comprises fibers having an effective diameter under 10 μm.

The filter media may also be characterized in that the first layer comprises fibers having a non-circular cross-sectional area.

The filter media may also be characterized in that the first layer comprises a lofty non-woven porous fibrous web.

The filter media may also be characterized in that the first layer comprises a membrane.

The filter media may also be characterized in that the filter media is formed into a respirator.

The filter media may also be characterized in that the respirator comprises a disposable respirator, a reusable respirator, a hybrid disposable-reusable respirator, or a PAPR.

The filter media may also be characterized in that one of the first and second layers comprises wrinkled media.

The filter media may also be characterized in that the first or second layer comprises a membrane.

The filter media may also be characterized in that the membrane is a wrinkled membrane.

The filter media may also be characterized in that the filter media is formed for use as an air conditioning filter.

The filter media may also be characterized in that the filter media is formed for use as a furnace filter.

The filter media may also be characterized in that the filter media is formed for a personal air purifier.

A filter media is presented that includes a first layer comprising a first nonwoven material and a second layer comprising a second nonwoven material. One of the first or second layer comprises wrinkled media. The wrinkled media includes a nonwoven sheet comprising a first series of substantially parallel non-bonded elastic filaments between a first and a second non-woven porous fibrous web. The first non-woven porous fibrous web is directly bonded to the second non-woven porous fibrous web. At least one portion of the shirred filter media is resiliently extensible under tension.

The filter media may also be characterized in that it includes a third layer adjacent the first layer on a first side, and adjacent the second layer on a second side, such that air flowing through the filter flows through the first layer, then the third layer, then the second layer.

The filter media may also be characterized in that the first layer is a high-loading-capacity layer.

The filter media may also be characterized in that the second layer is a high-efficiency layer.

The filter media may also be characterized in that the first layer includes the wrinkled media.

The filter media may also be characterized in that the wrinkled media is a first wrinkled media. The second layer comprises a second wrinkled media, and the first wrinkled media differs from the second wrinkled media in one of: a fiber type, a fiber thickness, an elastic filament type, or a spacing between adjacent elastic filaments.

The filter media may also be characterized in that the first non-woven porous fibrous web comprises meltblown fibers.

The filter media may also be characterized in that the first non-woven porous fibrous web comprises fibrillated film.

The filter media may also be characterized in that the first non-woven porous fibrous web comprises spunbond fibers.

The filter media may also be characterized in that the first non-woven porous fibrous web comprises fibers having a diameter under 40 μm.

The filter media may also be characterized in that the first non-woven porous fibrous web comprises fibers having a diameter under 20 μm.

The filter media may also be characterized in that the first non-woven porous fibrous web comprises fibers having a diameter under 15 μm.

The filter media may also be characterized in that the first non-woven porous fibrous web comprises fibers having a diameter under 10 μm.

The filter media may also be characterized in that the first non-woven porous fibrous web is a lofty non-woven porous fibrous web.

The filter media may also be characterized in that the non-woven sheet is a first non-woven sheet. The first layer comprises a second non-woven sheet.

The filter media may also be characterized in that the second non-woven sheet and the first non-woven sheet comprise the same media.

The filter media may also be characterized in that the filter is formed into a disposable respirator.

The filter media may also be characterized in that the filter is formed for use in a PAPR.

A filter for a respiratory device is presented that includes a high-loading-capacity layer configured to adsorb a majority of particulates filtered by the filter. The filter also includes a high-efficiency layer configured to adsorb a high percentage of particulates in an airstream that passes through the high efficiency layer. The filter is configured such that, when worn by a user, air passes through the high capacity layer before passing through the high efficiency layer. One of the high-loading-capacity layer or the high-efficiency layers comprise wrinkled media.

The filter may also be characterized in that the high-loading capacity layer or the high-efficiency layer comprises a membrane.

The filter may also be characterized in that the membrane is wrinkled.

The filter may also be characterized in that the high-loading-capacity layer comprises wrinkled media. The wrinkled media comprises a lofty non-woven media.

The filter may also be characterized in that the high-efficiency layer comprises wrinkled media.

The filter may also be characterized in that the high-loading-capacity layer includes a first wrinkled media, the high efficiency layer comprises a second wrinkled media, and the first wrinkled media is different from the second wrinkled media.

The filter may also be characterized in that the high-loading-capacity layer comprises depth-loading media.

The filter may also be characterized in that the high-efficiency layer comprises surface-loading media.

The filter may also be characterized in that the high-loading-capacity layer or the high-efficiency layer comprises meltblown fibers.

The filter may also be characterized in that the high-loading-capacity layer or the high-efficiency layer comprises.

The filter may also be characterized in that the high-loading-capacity layer or the high-efficiency layer comprises spunbond fibers.

The filter may also be characterized in that the high-loading-capacity layer or the high-efficiency layer comprises fibers having a diameter under 40 μm.

The filter may also be characterized in that the high-loading-capacity layer or the high-efficiency layer comprises fibers having a diameter under 20 μm.

The filter may also be characterized in that the high-loading-capacity layer or the high-efficiency layer comprises fibers having a diameter under 15 μm.

The filter may also be characterized in that the high-loading-capacity layer or the high-efficiency layer includes fibers having a diameter under 10 μm.

The filter may also be characterized in that the respirator is a disposable respirator.

The filter may also be characterized in that the filter is molded into a cup-shape.

The filter may also be characterized in that the filter is formed into a vertical fold or horizontal fold disposable respirator.

The filter may also be characterized in that the respirator is a powered air purifying respirator (PAPR).

The filter may also be characterized in that the respirator is shaped to fit within a housing of the PAPR.

The filter may also be characterized in that the high-loading-capacity layer has a first thickness, the high efficiency layer has a second thickness. The first and second thicknesses are different.

The filter may also be characterized in that the high-loading-capacity layer is composed of a first sheet of wrinkled media and a second sheet of wrinkled media.

The filter may also be characterized in that the high-efficiency layer is composed of a first sheet of wrinkled media and a second sheet of wrinkled media.

The filter may also be characterized in that it includes a transition layer between the first layer and the second layer, such that air passing through the filter passes through the first layer before passing through the transition layer.

A method of forming a respiratory filter media is presented that includes forming a high-loading-capacity zone, the high-loading-capacity zone comprising a first nonwoven media, forming a high-efficiency zone, the high efficiency zone comprising a second nonwoven media, and sealing the high-loading-capacity and the high-efficiency zones to form the respiratory filter. One of the first and second nonwoven media comprise wrinkled media.

The method may further be implemented such that the high loading capacity zone or the high-efficiency zone comprises a membrane.

The method may further be implemented such that the membrane is wrinkled.

The method may further be implemented such that the first nonwoven media includes a first sheet of wrinkled media and a second sheet of wrinkled media.

The method may further be implemented such that the second nonwoven media comprises a third sheet of wrinkled media and a fourth sheet of wrinkled media.

The method may further be implemented such that the first nonwoven media is selected for depth-loading of particles.

The method may further be implemented such that the second nonwoven media is selected for surface-loading of particles.

The method may further be implemented such that sealing comprises sealing the high-loading-capacity zone separately from the high-efficiency zone.

The method may further be implemented such that sealing comprises simultaneously sealing the second nonwoven media and the first nonwoven media together.

The method may further be implemented such that sealing comprises die-cutting.

The method may further be implemented such that sealing comprises applying an adhesive.

The method may further be implemented such that sealing comprises welding.

The method may further be implemented such that sealing comprises stitching.

The method may further be implemented such that it includes: placing the filter media in a housing.

The method may further be implemented such that the first nonwoven media comprises a first wrinkled media, the second nonwoven media includes a second wrinkled media. The first wrinkled media is different from the second wrinkled media in one of: a fiber type, a fiber thickness, an elastic filament type, or a spacing between adjacent elastic filaments.

The method may further be implemented such that it includes forming a transition zone. The transition zone includes a third nonwoven media. Sealing includes sealing the high-loading-capacity and high-efficiency zones such that air flows through the respiratory filter through the high-loading-capacity zone before the transition zone and before the high-efficiency zone.

The method may further be implemented such that at least two of the high-efficiency zone, the high-loading-capacity zone and the transition zone include wrinkled media.

The method may further be implemented such that each of the high-efficiency zone, the high-loading-capacity zone and the transition zone comprise wrinkled media.

The method may further be implemented such that the high-loading-capacity layer comprises depth-loading media.

The method may further be implemented such that the high-efficiency layer includes surface-loading media.

The method may further be implemented such that the high-loading-capacity layer or the high-efficiency layer includes meltblown fibers.

The method may further be implemented such that the high-loading-capacity layer or the high-efficiency layer includes fibrillated film fibers.

The method may further be implemented such that the high-loading-capacity layer or the high-efficiency layer includes spunbond fibers.

The method may further be implemented such that the high-loading-capacity layer or the high-efficiency layer includes fibers having a diameter under 40 μm.

The method may further be implemented such that the high-loading-capacity layer or the high-efficiency layer includes fibers having a diameter under 20 μm.

The method may further be implemented such that the high-loading-capacity layer or the high-efficiency layer includes fibers having a diameter under 15 μm.

The method may further be implemented such that the high-loading-lcapacity layer or the high-efficiency layer includes fibers having a diameter under 10 μm.

The method may further be implemented such that wherein the respirator is a disposable respirator.

The method may further be implemented such that the filter is molded into a cup-shape.

The method may further be implemented such that the filter is formed into a vertical fold or horizontal fold disposable respirator.

The method may further be implemented such that the respirator is a powered air purifying respirator (PAPR).

A filter media is presented that includes a first layer including a first plurality of fibers. The first plurality of fibers have an average diameter of less than or equal to about 50 microns, a thickness greater than or equal to about 1.0 mm, and a basis weight of greater than or equal to about 30 gsm. The first layer has an initial NaCl efficiency of less than or equal to about 50% at 14 cm/s face velocity. A second layer includes a second plurality of fibers, the second plurality of fibers having an average diameter of greater than or equal to 8 microns. The second layer has an initial NaCl efficiency of greater than or equal to about 50% at 14 cm/s face velocity.

The filter media may be implemented such that it includes a third layer, including a third plurality of fibers, the third plurality of fibers including: an average diameter of less than or equal to about 8 microns, an initial NaCl efficiency of greater than or equal to about 65% at 14 cm/s face velocity, and the NaCl efficiency of the third layer is great than the initial NaCl efficiency of the second layer.

The filter media may be implemented such that at least a portion of the third plurality of fibers are in contact with a portion of the second plurality of layers.

The filter media may be implemented such that the initial NaCl efficiency is greater than or equal to about 95% at 14 cm/s face velocity.

The filter media may be implemented such that the initial NaCl efficiency of the filter media is greater than or equal to about 90% at 14 cm/s face velocity.

The filter media may be implemented such that the initial NaCl efficiency of the filter media is greater than or equal to about 75% at 14 cm/s face velocity.

The filter media may be implemented such that the initial NaCl efficiency of the filter media is greater than or equal to about 50% at 14 cm/s face velocity.

The filter media may be implemented such that the initial pressure drop of the filter media is less than or equal to about 2.0 mm H2O at 14 cm/s face velocity.

The filter media may be implemented such that the first layer includes wrinkled media.

The filter media may be implemented such that the first layer includes a sorbent.

The filter media may be implemented such that the first layer includes meltblown fibers.

The filter media may be implemented such that the layer includes fibrillated film.

The filter media may be implemented such that the first layer includes spunbond fibers.

The filter media may be implemented such that the first layer includes fibers with a discrete length.

The filter media may be implemented such that the first layer includes fibers having an effective diameter under 50 μm.

The filter media may be implemented such that the first layer fibers having an effective diameter under 35 μm.

The filter media may be implemented such that the first layer includes fibers having an effective diameter under 25 μm.

The filter media may be implemented such that the first layer includes fibers having an effective diameter under 20 μm.

The filter media may be implemented such that the first layer includes fibers having a non-circular cross-sectional area.

The filter media may be implemented such that the first layer includes a lofty non-woven porous fibrous web.

The filter media may be implemented such that one of the first and second layers includes wrinkled media.

The filter media may be implemented such that the filter media is formed for use with an air conditioning device.

The filter media may be implemented such that the filter media is formed for use with heating, ventilation, and/or air conditioning equipment.

The filter media may be implemented such that the filter media is formed for use with a portable air purifier.

The filter media may be implemented such that the filter media is formed for use with a portable fan.

A filter media is presented that includes a first layer including a first nonwoven material and a second layer including a second nonwoven material. One of the first or second layer includes wrinkled media. The wrinkled media includes: a nonwoven sheet including a first series of substantially parallel non-bonded elastic filaments between a first and a second non-woven porous fibrous web. The first non-woven porous fibrous web is directly bonded to the second non-woven porous fibrous web. At least one portion of the shirred filter media is resiliently extensible under tension.

The filter media may be implemented such that it includes a third layer adjacent the first layer on a first side, and adjacent the second layer on a second side, such that air flowing through the filter flows through the first layer, then the third layer, then the second layer.

The filter media may be implemented such that the first layer is a high-loading-capacity layer.

layer.

The filter media may be implemented such that the second layer is a high-efficiency

The filter media may be implemented such that the first layer includes the wrinkled media.

The filter media may be implemented such that the wrinkled media is a first wrinkled media, and the second layer includes a second wrinkled media, and the first wrinkled media differs from the second wrinkled media in one of: a fiber type, a fiber thickness, an elastic filament type, or a spacing between adjacent elastic filaments.

The filter media may be implemented such that the first non-woven porous fibrous web includes meltblown fibers.

The filter media may be implemented such that the first non-woven porous fibrous web includes fibrillated film.

The filter media may be implemented such that the first non-woven porous fibrous web includes spunbond fibers.

The filter media may be implemented such that the first non-woven porous fibrous web includes fibers with a discrete length.

The filter media may be implemented such that the first non-woven porous fibrous web includes fibers having a diameter under 50 μm.

The filter media may be implemented such that the first non-woven porous fibrous web includes fibers having a diameter under 35 μm.

The filter media may be implemented such that the first non-woven porous fibrous web includes fibers having a diameter under 25 μm.

The filter media may be implemented such that the first non-woven porous fibrous web includes fibers having a diameter under 20 μm.

The filter media may be implemented such that the first non-woven porous fibrous web is a lofty non-woven porous fibrous web.

The filter media may be implemented such that the non-woven sheet is a first non-woven sheet, and the first layer includes a second non-woven sheet.

The filter media may be implemented such that the second non-woven sheet and the first non-woven sheet include the same media.

The filter media may be implemented such that the filter media is formed for use with heating, ventilation, and/or air conditioning equipment.

The filter media may be implemented such that the filter media is formed for use with an air conditioning device.

The filter media may be implemented such that the filter media is formed for use with a portable air purifier.

The filter media may be implemented such that the filter media is formed for use with a portable fan.

A filter for an air treatment device is presented that includes a high-loading-capacity layer configured to adsorb a majority of particulates filtered by the filter and a high-efficiency layer configured to adsorb a high percentage of particulates in an airstream that passes through the high efficiency layer. The filter is configured such that, when in use, air passes through the high capacity layer before passing through the high efficiency layer. One of the high-loading-capacity layer or the high-efficiency layers include wrinkled media.

The filter may be implemented such that the high-loading-capacity layer includes wrinkled media, and the wrinkled media includes a lofty non-woven media.

The filter may be implemented such that the high-efficiency layer includes wrinkled media.

The filter may be implemented such that the high-loading-capacity layer includes a first wrinkled media, the high efficiency layer includes a second wrinkled media, and the first wrinkled media is different from the second wrinkled media.

The filter may be implemented such that the high-loading-capacity layer includes depth-loading media.

The filter may be implemented such that the high-efficiency layer includes surface-loading media.

The filter may be implemented such that the high-loading-capacity layer or the high-efficiency layer includes meltblown fibers.

The filter may be implemented such that the high-loading-capacity layer or the high-efficiency layer includes.

The filter may be implemented such that the high-loading-capacity layer or the high-efficiency layer includes spunbond fibers.

The filter may be implemented such that the high-loading-capacity layer or the high-efficiency layer includes fibers with a discrete length.

The filter may be implemented such that the high-loading-capacity layer or the high-efficiency layer includes fibers having a diameter under 50 μm.

The filter may be implemented such that the high-loading-capacity layer or the high-efficiency layer includes fibers having a diameter under 35 μm.

The filter may be implemented such that the high-loading-capacity layer or the high-efficiency layer includes fibers having a diameter under 25 μm.

The filter may be implemented such that the high-loading-capacity layer or the high-efficiency layer includes fibers having a diameter under 20 μm.

The filter may be implemented such that the high-loading-capacity layer has a first thickness, the high efficiency layer has a second thickness, and the first and second thicknesses are different.

The filter may be implemented such that the high-loading-capacity layer is composed of a first sheet of wrinkled media and a second sheet of wrinkled media.

The filter may be implemented such that the high-efficiency layer is composed of a first sheet of wrinkled media and a second sheet of wrinkled media.

The filter may be implemented such that it includes a transition layer between the first layer and the second layer, such that air passing through the filter passes through the first layer before passing through the transition layer.

The method may be implemented such that the filter is a heating, ventilation, and/or air conditioning equipment filter.

The method may be implemented such that the filter is an air conditioning device filter.

The method may be implemented such that the filter is a portable air purifier filter.

The method may be implemented such that the filter is a portable fan filter.

A method of forming a filter media is presented that includes forming a high-loading-capacity zone, the high-loading-capacity zone including a first nonwoven media, forming a high-efficiency zone, the high efficiency zone including a second nonwoven media, and bonding the high-loading-capacity and the high-efficiency zones to form the filter media. One of the first and second nonwoven media include wrinkled media.

The method may be implemented such that the first nonwoven media includes a first sheet of wrinkled media and a second sheet of wrinkled media.

The method may be implemented such that the second nonwoven media includes a third sheet of wrinkled media and a fourth sheet of wrinkled media.

The method may be implemented such that the first nonwoven media is selected for depth-loading of particles.

The method may be implemented such that the second nonwoven media is selected for surface-loading of particles.

The method may be implemented such that bonding includes bonding the high-loading-capacity zone separately from the high-efficiency zone.

The method may be implemented such that bonding includes simultaneously bonding the second nonwoven media and the first nonwoven media together.

The method may be implemented such that bonding includes die-cutting.

The method may be implemented such that bonding includes applying an adhesive.

The method may be implemented such that bonding includes welding.

The method may be implemented such that bonding includes stitching.

The method may be implemented such that it includes placing the filter media in a housing or frame.

The method may be implemented such that the first nonwoven media includes a first wrinkled media, the second nonwoven media includes a second wrinkled media, and the first wrinkled media is different from the second wrinkled media in one of: a fiber type, a fiber thickness, an elastic filament type, or a spacing between adjacent elastic filaments.

The method may be implemented such that it includes forming a transition zone, the transition zone includes a third nonwoven media, and wherein bonding includes bonding the high-loading-capacity and high-efficiency zones such that air flows through the respiratory filter through the high-loading-capacity zone before the transition zone and before the high-efficiency zone.

The method may be implemented such that at least two of the high-efficiency zone, the high-loading-capacity zone and the transition zone include wrinkled media.

The method may be implemented such that each of the high-efficiency zone, the high-loading-capacity zone and the transition zone include wrinkled media.

The method may be implemented such that the high-loading-capacity layer includes depth-loading media.

The method may be implemented such that the high-efficiency layer includes surface-loading media.

The method may be implemented such that the high-loading-capacity layer or the high-efficiency layer includes meltblown fibers.

The method may be implemented such that the high-loading-capacity layer or the high-efficiency layer includes fibrillated film fibers.

The method may be implemented such that the high-loading-capacity layer or the high-efficiency layer includes spunbond fibers.

The method may be implemented such that the high-loading-capacity layer or the high-efficiency layer includes fibers with a discrete length.

The method may be implemented such that the high-loading-capacity layer or the high-efficiency layer includes fibers having a diameter under 50 μm.

The method may be implemented such that the high-loading-capacity layer or the high-efficiency layer includes fibers having a diameter under 35 μm.

The method may be implemented such that the high-loading-capacity layer or the high-efficiency layer includes fibers having a diameter under 25 μm.

The method may be implemented such that the high-loading-capacity layer or the high-efficiency layer includes fibers having a diameter under 20 μm.

The method may be implemented such that the filter media is formed for use with heating, ventilation, and/or air conditioning equipment.

The method may be implemented such that the filter media is formed for use with an air conditioning device.

The method may be implemented such that the filter media is formed for use with a portable air purifier.

The method may be implemented such that the filter media is formed for use with a portable fan.

### Comparative Examples 1~4 (CE 1 to CE 4) and Example 1 (EX 1)

Sample making Method 1 was used in making CE 1-4 and EX 1 that comprised of various layers of webs as listed in Table 3.

Table 5 shows the test results of 144 cm² of media samples in silica loading tests at 74 LPM flow rate, i.e. at a face velocity of about 8.6 cm/s. The pressure drop (or dP) Initial was measured before silica loading and pressure drop Final was measured after silica loading. The silica LQF of EX 1 is significantly higher than those of CE 1 through CE 4.

TABLE 5
Silica loading test results of CE1-4 and EX 1

| | Examples of Type 1 Composite Depth Media | | | | |
|---|---|---|---|---|---|
| | | Silica loading test at 8.6 cm/s | | | |
| | CE 1 | CE 2 | CE 3 | CE 4 | EX 1 |
| 1^{st} Inlet layer | 12 μm | HL 85 | HL 85 | GSU 150 | GSU 150 |
| | meltblown | | | | |
| 2^{nd} layer | 12 μm | HL 85 | HL 85 | 5 μm | 12 μm |
| | meltblown | | | meltblown | meltblown |
| 3^{rd} or Outlet layer | 5 μm | 12 μm | HL 85 | 5 μm | 5 μm |
| | meltblown | meltblown | | meltblown | meltblown |
| 4^{th} or Outlet layer | 5 μm | 5 μm | 12 μm | — | — |
| | meltblown | meltblown | meltblown | | |
| 5^{th} or Outlet layer | — | — | 5 μm | — | — |
| | | | meltblown | | |
| % Pen | 0.64 | 0.07 | 0.14 | 0.03 | 0.14 |
| dP Initial (mmH₂O) | 22.8 | 11.0 | 11.4 | 22.7 | 10.7 |
| dP Final (mmH₂O) | 213 | 138 | 116 | 52.8 | 21.0 |
| Silica LQF | 0.02 | 0.05 | 0.06 | 0.22 | 0.64 |
| (mg/mmH₂O/cm²) | | | | | |

### Comparative Examples 5-6 (CE 5 to CE 6) and Examples 2-4 (EX 2 to EX 4)

Sample making Method 1 was used in making CE 5-6 and EX 2-4 comprised of various layers of webs as listed in Table 3.

Table 6 shows the test results of 102 cm² of media samples in silica loading tests at 43 LPM flow rate, i.e. at a face velocity of about 7 cm/s. The media pressure drop Initial was measured before silica loading and pressure drop Final was measured after silica loading. The silica LQF of EX 2-EX 4, are significantly higher than those for CE 5 and CE 6.

TABLE 6
Silica loading test results of CE 5-6 and EX 2-4

| | Examples of Type 1 Composite Depth Media | | | | |
|---|---|---|---|---|---|
| | | Silica loading test at 7 cm/s | | | |
| | CE 5 | CE 6 | EX 2 | EX 3 | EX 4 |
| 1^{st} Inlet layer | GSU 90 | GSU 90 | GSU 50 | GSU 70 | GSU 150 |
| 2^{nd} layer | 5 μm | HL 85 | GSU 90 | GSU 90 | 12 μm |
| | meltblown | | | | meltblown |
| 3^{rd} or Outlet layer | 5 μm | 5 μm | 12 μm | 12 μm | 5 μm |
| | meltblown | meltblown | meltblown | meltblown | meltblown |
| 4^{th} or Outlet layer | — | — | 5 μm | 5 μm | — |
| | | | meltblown | meltblown | |
| % Pen | 0.02 | 0.017 | 0.06 | 0.09 | 0.05 |
| dP Initial (mmH₂O) | 14.5 | 7.6 | 9.7 | 10.5 | 8.8 |
| dP Final (mmH₂O) | 68.1 | 25.1 | 12.9 | 15.0 | 13.4 |
| Silica LQF | 0.10 | 0.33 | 1.59 | 1.48 | 1.25 |
| (mg/mmH₂O/cm²) | | | | | |

Two pleated media packs used in PAPRs were tested for silica loading as comparative examples CE 7 and CE 8. The pleat packs were made with glassfiber media HB6643 available from Hollingsworth & Vose (112 Washington Street East Walpole, MA 02032 USA). The pleat pack dimensions, test conditions and tests results are listed in Table 7. Even if the test face velocity for pleat packs were much lower than that for above media samples, the LQF of CE 7 and CE 8 were still much lower than EX 2-4.

TABLE 7
Silica loading test results of CE 7 and CE 8
Examples of Pleated Media Packs

| | Silica loading | Silica loading |
|---|---|---|
| | test at | test at |
| | 2.6 cm/s | 1.7 cm/s |
| | CE 7 | CE 8 |
| Pleat Height (mm) | 15.5 | 23.5 |
| Pleat Density (pleat per inch) | 11 | 11 |
| Total surface area (cm²) | 1406 | 2132 |
| Test Flow Rate (LPM) | 220 | 220 |
| Test duration (min) | 240 | 240 |
| Total Silica Challenged | 60.7 | 56.5 |
| (mg/m³) | | |
| % Pen | 0.14 | 0.02 |
| dP Initial (mmH₂O) | 17.8 | 11.9 |
| dP Final (mmH₂O) | 66.9 | 28.3 |
| Silica LQF (mg/mmH₂O/cm²) | 0.04 | 0.08 |

### Comparative Example 9 (CE 9) and Examples 5-9 (EX 5 to EX 9)

Sample making Methods 1, 2 and 3 were used in making CE 9 and EX 5-9 comprised of various layers of webs as listed in Tables 3 and 4.

Table 8 shows the test results of 102 cm² of media samples in silica loading tests at 85 LPM flow rate, i.e. at a face velocity of about 14 cm/s for flat sheets. The media pressure drop Initial was measured before silica loading and pressure drop Final was measured after silica loading. The LQF of EX 5 and EX 6 with wrinkled media had much higher LQF.

TABLE 8
Silica loading test results of CE 9 and EX 5-9
Examples of Type 1, 2 and 3 Composite Depth Media

| | Silica loading test at 14 cm/s | | | | | |
|---|---|---|---|---|---|---|
| | CE 9 | EX 5 | EX 6 | EX 7 | EX 8 | EX 9 |
| 1^{st} Inlet layer | GSU 150 | GSU 150 | GSU 150 | UHL × 3 | Wrinkled | Wrinkled |
| | | | | | GDU 150 + | UHL × 2 |
| | | | | | 7.5 μm | |
| | | | | | meltblown | |
| 2^{nd} or Outlet layer | 12 μm | Wrinkled | Wrinkled | Wrinkled | — | Wrinkled |
| | meltblown | 12.5 + 5 μm | 7.5 μm × 2 | 7.5 μm × 2 | | UHL + 7.5 |
| | | meltblown | meltblown | meltblown | | meltblown |
| Outlet layer | 5 μm | — | — | — | — | — |
| | meltblown | | | | | |
| % Pen | 0.01 | 0.01 | 0.04 | 0.02 | 0.01 | 0.02 |
| dP Initial (mmH₂O) | 18.1 | 12.1 | 11.5 | 13.2 | 6.9 | 6.2 |
| dP Final (mmH₂O) | 56.2 | 24.9 | 21.7 | 34.35 | 36.9 | 14.7 |
| Silica LQF | 0.33 | 0.90 | 0.97 | 0.54 | 0.38 | 1.3 |
| (mg/mmH₂O/cm²) | | | | | | |

### Comparative Examples 10-12 (CE 10 to CE 12) and Examples 10-11 (EX 10 to EX 12)

Sample making Methods 1 and 2 were used in making CE 10 and EX 4-8 comprised of various layers of webs as listed in Table 3.

Table 9 shows the test results of 78.5 cm² of media samples in welding fume particle loading tests at 66 LPM flow rate, i.e. at a face velocity of about 14 cm/s. The pressure drop Delta is the pressure drop increase after loading of approximately 150 mg of welding fume particles on media.

TABLE 9
Welding fume particle loading test results of CE 10-12 and EX 10-12
Examples of Type 1 and 2 Composite Depth Media

| | Welding fume loading test at 14 cm/s | | | | | |
|---|---|---|---|---|---|---|
| | CE 10 | CE 11 | CE 12 | EX 10 | EX 11 | EX 12 |
| 1^{st} Inlet layer | GSU 150 | UHL × 2 | UHL × 3 | GSU 150 | Wrinkled | Wrinkled |
| | | | | | UHL × 2 | UHL × 2 |
| 2^{nd} layer | 12 μm | 12 μm | 7.5 μm | Wrinkled | Wrinkled | Wrinkled |
| | meltblown | meltblown | meltblown | 12.5 + 7.5 | 12.5 + 7.5 | UHL + 7.5 |
| | | | | μm meltblown | μm meltblown | μm meltblown |
| 3^{rd} or Outlet layer | 5 μm | 5 μm | — | — | — | — |
| | meltblown | meltblown | | | | |
| % Pen | 0.07 | — | 0.09 | — | — | 0.05 |
| dP Initial (mmH₂O) | 5.3 | 4.0 | 2.3 | 3.26 | 4.2 | 2.4 |
| dP Final (mmH₂O) | 25.5 | 56.4 | 58.6 | 11.42 | 13.7 | 16.5 |
| at 150 mg loading | | | | | | |
| Welding fume LQF | 0.09 | 0.04 | 0.03 | 0.23 | 0.21 | 0.11 |
| (mg/mmH₂O/cm²) | | | | | | |

### Comparative Examples 13-14 (CE 13 to CE 14) and Examples 13-14 (EX 13 to EX 14)

Sample making Methods 1 and 3 were used in making CE 13-14 and EX 13-14 comprised of various layers of webs as listed in Tables 3 and 4.

Table 10 shows the test results of 102 cm² of media samples in NaCl loading tests at 85 LPM flow rate, i.e. at a face velocity of about 13.9 cm/s. The media pressure drop Initial was measured before NaCl loading and pressure drop Final was measured after loading.

TABLE 10
NaCl loading test results of CE 13-14 and EX 13-14
Examples of Type 1 and 2 Composite Depth Media

| | NaCl loading at 13.9 cm/s | | | |
|---|---|---|---|---|
| | CE 13 | EX 13 | CE 14 | EX 14 |
| Inlet layer | 12.5 μm | Wrinkled | 7.5 μm | Wrinkled |
| | meltblown | 12.5 + 5 μm | meltblown | 7.5 + 5 μm |
| | | meltblown | | meltblown |
| Outlet layer | 5 μm | — | 5 μm | — |
| | meltblown | | meltblown | |
| % Pen max during | 0.016 | 0.004 | 0.007 | 0.004 |
| loading up to 50 mg | | | | |
| dP Initial (mmH₂O) | 15.5 | 12.1 | 19.0 | 16.4 |
| dP Final (mmH₂O), | 30 | 17 | 40 | 21 |
| at 50 mg loading | | | | |
| NaCl LQF (mg/mmH₂O/cm²) | 0.03 | 0.10 | 0.02 | 0.11 |

### Comparative Examples 15 (CE 15) and Examples 15 (EX 15)

Sample making Methods 4 was used in making CE 15 and EX 15 comprised of various layers of webs as listed in Tables 3 and 4.

Table 11 shows the test results of respirator samples in NaCl loading tests at 85 LPM flow rate, i.e. at a face velocity of about 13.9 cm/s. The pressure drop Initial was measured before NaCl loading and pressure drop Final was measured after loading.

Note, for easy comparison, the NaCl LQF here is based on the entire respirator area versus per unit surface area.

TABLE 11
NaCl loading test results of CE 15- and EX 15
Examples of Respirator with Composite Depth Media

NaCl loading at 13.9 cm/s

| | CE 15 | EX 15 |
|---|---|---|
| Inlet layer | GDU 150 | Wrinkled GDU |
| | | 150 + 7.5 μm |
| | | meltblown |
| Outlet layer | 7.5 μm | — |
| | meltblown | |
| % Pen max during | 0.775 | 0.438 |
| loading up to 50 mg | | |
| dP Initial (mmH₂O) | 7.2 | 7 |
| dP Final (mmH₂O), | 13.5 | 9.3 |
| at 100 mg loading | | |
| NaCl LQF (mg/mmH₂O/filter) | 15.9 | 43.5 |

1-11. (canceled)

12. A filter media comprising:
a first layer comprising a first nonwoven material;
a second layer comprising a second nonwoven material; and
wherein one of the first or second layer comprises wrinkled media, the wrinkled media comprising:
a nonwoven sheet comprising a first series of substantially parallel non-bonded elastic filaments between a first and a second non-woven porous fibrous web;
wherein the first non-woven porous fibrous web is directly bonded to the second nonwoven porous fibrous web; and
wherein at least one portion of the shirred filter media is resiliently extensible under tension.

13. The filter media of claim 12, and further comprising:
a third layer adjacent the first layer on a first side, and adjacent the second layer on a second side, such that air flowing through the filter flows through the first layer, then the third layer, then the second layer.

14. The filter media of claim 12, wherein the first layer is a high-loading-capacity layer.

15. The filter media of claim 12, wherein the second layer is a high-efficiency layer.

16. The filter media of claim 13, wherein the wrinkled media is a first wrinkled media, and wherein the second layer comprises a second wrinkled media, and wherein the first wrinkled media differs from the second wrinkled media in one of: a fiber type, a fiber thickness, an elastic filament type, or a spacing between adjacent elastic filaments.

17. The filter media of claim 12, wherein the first non-woven porous fibrous web comprises fibers having a diameter under 40 μm.

18. The filter media of claim 12, wherein the filter is formed for use in a PAPR.

19-40. (canceled)
